(19) United States
(12) Patent Application Publication
(10) Pub. No.: US 2002/0051075 A1
(43) Pub. Date: May 2, 2002

(54) Portable image pickup apparatus wearable on a wrist and attachments for the apparatus

(75) Inventors: Ryusuke Yamaguchi, Tokyo (JP); Naohiko Sakurazawa, Tokyo (JP)

Correspondence Address: FRISHAUF, HOLTZ, GOODMAN &, LANGER & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 09/901,528

(22) Filed: Jul. 9, 2001

(30) Foreign Application Priority Data
Jul. 13, 2000 (JP) 2000-212986
Jun. 12, 2001 (JP) 2001-177022

(51) Int. Cl. H04N 7/18; H04N 5/225

(52) U.S. Cl. 348/376; 348/61

(57) ABSTRACT

A portable image pickup apparatus comprising a camera in the apparatus proper. The apparatus comprises an attachment fittable over the apparatus proper and having a part that aligns with at least an image pickup lens 6 of the camera unit. The part has a special image pickup function unit (telescopic lens) to give a special image pickup effect to an image picked up by the camera unit.

### BACKGROUND OF THE INVENTION

1. Field of the Invention

The present invention relates to portable image pickup apparatus wearable on a wrist and attachments for the apparatus.

2. Background Art

Digital still cameras have diffused that digitize and store picked-up images. Recently, parts of image pickup apparatus such as CCD (Charge Coupled Device) modules and CMOS (Complementary Metal-Oxide Semiconductor) sensors that compose a part of image pickup apparatus have been miniaturized greatly. This has brought about high-density incorporation of such components into the image pickup apparatus and hence the advent of small-sized and portable (for example, wrist-wearable) images pickup apparatus.

Addition of functions of zooming-in (×2, ×4) on an image to be picked up and/or producing a special optical effect such as cuts light of a specified wavelength to an image pickup apparatus increases the convenience of handling the apparatus for the user. However, as is known generally, a conventional method of additionally providing options (or attachments) to an image pickup apparatus has impaired portability and operability of the image pickup apparatus. For example, addition of an optional function such as the special optical effect to a portable image pickup apparatus would compound the structure and operating method of the apparatus. Such apparatus would not be handy for the user, and reduce a maker's productivity and renders maintain less effective.

### SUMMARY OF THE INVENTION

It is therefore an object of the present invention to provide a portable image pickup apparatus comprising a removable attachment therefor that can easily produce additional special optical effects without impairing portability and operability of the apparatus for the user and without lowering the productivity and maintenance for the maker. The present invention also provides such attachment.

According to the present invention, the attachment is attached to the image pickup apparatus proper so as to provide a light transmission part that covers a lens of a camera of the apparatus. The light transmission part can easily give a special optical effect to a picked-up image. The attachment is attached to the apparatus proper so as to avoid a band attaching unit of the apparatus, so that even in a state where the attachment is attached to the apparatus proper, the portability and operability of the apparatus is not impaired to thereby contribute to a reduction in the apparatus size.

### BRIEF DESCRIPTION OF THE DRAWINGS

FIG. 1 is a plan view of one embodiment of a wristwatch-type image pickup apparatus according to the present invention;

FIG. 2 is an enlarged plan view of the image pickup apparatus proper of FIG. 1;

FIG. 3 is a perspective view of the image pickup apparatus proper of FIG. 2;

FIG. 4 is a front view of the image pickup apparatus proper of FIG. 3, showing a camera unit and an optical communication unit thereof;

FIG. 5 is a side view of the apparatus proper of FIG. 4;

FIG. 6 is a perspective view of the apparatus portion of FIG. 3, showing the opposite side of the apparatus proper from the camera unit and optical communication unit thereof;

FIG. 7 is a perspective view of the apparatus proper in which a cover is illustrated as being separated from the camera and optical communication unit of FIG. 4;

FIGS. 8A, 8B and 8C are an end view, a plan view and a cross-sectional view, respectively, of a first embodiment of an attachment according to the present invention;

FIGS. 9A, 9B and 9C are an end view, a plan view and a cross-sectional view, respectively, of the attachment of FIGS. 8A, 8B and 8C fitted over the apparatus proper of FIGS. 1-6;

FIG. 10 is a schematic perspective view of the apparatus proper to which the attachment of FIGS. 9A, 9B and 9C is attached.

FIGS. 11A, 11B, and 11C is an end view, a plan view and a cross-sectional view, respectively, of a second embodiment of the attachment according to the present invention;

FIGS. 12A, 12B and 12C are an end view a plan view and a cross-sectional view, respectively, of the apparatus proper of FIGS. 1-7 to which the attachment of FIGS. 11A, 11B and 11C is attached;

FIG. 13 is a schematic perspective view of the apparatus proper to which the attachment of FIGS. 12A, 12B and 12C is attached.

FIGS. 14A, 14B and 14C are an end view, a plan view and a cross-sectional view, respectively, of a third embodiment of the attachment according to the present invention;

FIGS. 15A, 15B and 15C are an end view, a plan view and a cross-sectional view, respectively, of the apparatus proper of FIGS. 1-7 to which the attachment of FIGS. 14A, 14B and 14C is attached;

FIG. 16 is a schematic perspective view of the apparatus proper to which the attachment of FIGS. 15A, 15B and 15C is attached.

FIGS. 17A, 17B and 17C are an end view, a plan view and a cross-sectional view, respectively, of a fourth embodiment of the attachment according to the present invention;

FIGS. 18A, 18B and 18C are an end view, a plan view and a cross-sectional view, respectively, of the apparatus proper of FIGS. 1-7 to which the attachment of FIGS. 17A, 17B and 17C is attached;

FIG. 19 is a schematic perspective view of the apparatus proper to which the attachment of FIGS. 18A, 18B and 18C is attached.

FIGS. 20A, 20B and 20C are an end view, a plan view and a cross-sectional view, respectively, of a fifth embodiment of the attachment according to the present invention;

FIGS. 21A and 21B are a plan view and a cross-sectional view, respectively, of the apparatus proper of FIGS. 1-7 to which the attachment of FIGS. 20A, 21B and 21C is attached;

FIG. 22 is a schematic perspective view of the apparatus proper to which the attachment of FIGS. 21A and 21B is attached.

FIGS. 23A and 23B are a plan view and a side view, respectively, of a sixth embodiment of the attachment according to the present invention;

FIGS. 24A and 24B are a plan view and a cross-sectional view, respectively, of the apparatus proper of FIGS. 1-7 to which the attachment of FIGS. 23A and 23B is attached;

FIG. 25 is a schematic perspective view of the apparatus proper to which the attachment of FIGS. 24A and 24B is attached.

FIGS. 26A and 26B are a plan view and a side view, respectively, of a seventh embodiment of the attachment according to the present invention;

FIGS. 27A and 27B are a plan view and a cross-sectional view, respectively, of the apparatus proper of FIGS. 1-7 to which the attachment of FIGS. 26A and 26B is attached;

FIG. 28 is a schematic perspective view of the apparatus proper to which the attachment of FIGS. 27A and 27B is attached.

FIGS. 29A and 23B are a plan view and a side view, respectively, of the apparatus proper with a front 91 of the attachment being rotated from its position shown in FIGS. 27A and 27B;

FIG. 30 is a schematic perspective view of the apparatus proper with the front 91 of the attachment being rotated from its position shown in FIGS. 29A and 29B.

FIGS. 31A and 31B are a plan view and a side view, respectively, of an eighth embodiment of the attachment according to the present invention;

FIGS. 32A, 32B and 32C are a bottom view, a plan view and a cross-sectional view, respectively, of the apparatus proper of FIGS. 1-7 to which the attachment of FIGS. 31A and 31B is attached;

FIG. 33 is a schematic perspective view of the apparatus proper to which the attachment of FIGS. 32A, 32B and 32C is attached.

FIGS. 34A and 34B are a plan view and a side view, respectively, of a ninth embodiment of the attachment according to the present invention;

FIGS. 35A and 35B are a plan view and a cross-sectional view, respectively, of the apparatus proper of FIGS. 1-7 to which the attachment of FIGS. 34A and 34B is attached,

FIG. 36 is a schematic perspective view of the apparatus proper to which the attachment of FIGS. 35A and 35B is attached.

FIGS. 37A and 37B are a plan view and a side view, respectively, of a tenth embodiment of the attachment according to the present invention;

FIGS. 38A and 38B are a plan view and a cross-sectional view, respectively, of the apparatus proper of FIGS. 1-7 to which the attachment of FIGS. 37A and 37B is attached,

FIG. 39 is a schematic perspective view of the apparatus proper to which the attachment of FIGS. 38A and 38B is attached.

FIGS. 40A and 40B are a front view and a side view, respectively, of an eleventh embodiment of the attachment according to the present invention;

FIGS. 41A and 41B are a front view and a cross-sectional view, respectively, of a filter of the apparatus proper of FIGS. 1-7 to which the attachment of FIGS. 40A and 40B is attached, and FIG. 41C a plan view of the apparatus proper with such filter;

FIG. 42 is a schematic perspective view of the apparatus proper to which the attachment of FIG. 41C is attached.

FIGS. 43A and 43B are a plan view and across-sectional view, respectively, of a twelfth embodiment of the attachment according to the present invention;

FIGS. 44A and 44B are a plan view and a cross-sectional view, respectively, of a filter of the apparatus proper of FIGS. 1-7 to which the attachment of FIGS. 43A and 43B is attached; and FIG. 44C a plan view of the apparatus proper with such filter;

FIG. 45 is a schematic perspective view of the apparatus proper to which the attachment of FIG. 44C is attached.

FIGS. 46A, 46B and 46C are an end view, a plan view and a cross-sectional view, respectively, of a thirteenth embodiment of the attachment according to the present invention;

FIGS. 47A and 47B are front views of A and B special optical effect plates, respectively, which are inserted into the attachment of FIGS. 46A, 46B and 46C;

FIGS. 48A, 48B and 48C are an end view, a plan view and a cross-sectional view, respectively, of the apparatus proper of FIGS. 1-7 to which the attachment of FIGS. 46A, 46B and 46C is attached;

FIG. 49 is a schematic perspective view of the apparatus proper to which the attachment of FIGS. 46A, 46B and 46C is attached.

FIGS. 50A, 50B and 50C are an end view, a plan view and another end view, respectively, of a fourteenth embodiment of the attachment according to the present invention;

FIG. 51 is a front view of an especial effect plate that will be inserted into the attachment of FIGS. 50A, 50B and 50C;

FIG. 52 is a schematic perspective view of the apparatus proper to which the attachment of FIGS. 50A, 50B and 50C is attached.

FIGS. 53A, 53B and 53C are an end view, a plan view and a different end view, respectively, of a fifteenth embodiment of the attachment according to the present invention, wherein the different view of the embodiment involves a special effect plate being moved to a different position;

FIG. 54 is a front view of a special effect plate to be inserted into the attachment of FIGS. 53A, 53B and 53C;

FIG. 55 is a schematic perspective view of the apparatus proper of FIGS. 1-7 to which the attachment of FIGS. 53A, 53B and 53C is attached.

FIG. 56 is a front view of a sixteenth embodiment of the attachment according to the present invention;

FIG. 57 is a front view of an especial effect plate to be inserted into the attachment of FIG. 56;

FIG. 58 is a schematic perspective view of the apparatus proper to which the attachment of FIG. 56C is attached.

FIGS. 59A, 59B, 59C and 59D are an end view, a plan view, a different end view and a cross-sectional view, respectively, of a seventeenth embodiment of the attachment according to the present invention wherein the different view of the embodiment involves a different especial effect plate used;

FIGS. 60A, 60B and 60C are an end view, a plan view and a cross-sectional view, respectively, of the apparatus proper of FIGS. 1-7 to which the attachment of FIGS. 59A, 59B, 59C and 59D is attached;

FIG. 61 is a schematic perspective view of the apparatus proper to which the attachment of FIGS. 60A, 60B and 60C is attached.

FIGS. 62A and 62C are a plan view and a cross-sectional view, respectively, of an extension unit of an eighteenth embodiment of the attachment according to the present invention; and FIGS. 62B and 62D are a plan view and a cross-sectional view, respectively, of the eighteenth embodiment;

FIGS. 63A, 63B and 63C are an end view, a plan view and a cross-sectional view, respectively, of the attachment of FIGS. 62B and 62D into which the extension unit of FIGS. 62A and 62C is press fitted;

FIG. 64 is a schematic perspective view of the apparatus proper of FIGS. 1-7 to which the attachment of FIGS. 63A, 63B and 63C is attached.

FIGS. 65A and 65C are a plan view and a cross-sectional view, respectively, of an extension unit of a nineteenth embodiment of the attachment according to the present invention; and FIGS. 65B and 65D are a plan view and a cross-sectional view, respectively, of the eighteenth embodiment of the attachment;

FIGS. 66A, 66B and 66C are an end view, a plan view and a cross-sectional view, respectively, of the attachment of FIGS. 65B and 65D into which the extension unit of FIGS. 65A and 65C is press fitted;

FIG. 67 is a schematic perspective view of the apparatus proper of FIGS. 1-7 to which the attachment of FIGS. 66A, 66B and 66C is attached.

FIGS. 68Aand 68C are different cross-sectional views, respectively, of an extension unit of a twentieth embodiment of the attachment according to the present invention; and FIGS. 68B and 68D are a plan view and a cross-sectional view, respectively, of that attachment;

FIGS. 69A, 69B and 69C are an end view, a plan view and a cross-sectional view, respectively, of the attachment of FIGS. 68B and 68D into which the extension unit of FIGS. 68A and 68C is press fitted;

FIG. 70 is a schematic perspective view of the apparatus proper of FIGS. 1-7 to which the attachment of FIGS. 69A, 69B and 69C is attached.

FIG. 71 is a plan view of the apparatus proper of FIGS. 1-7 to which an attachment of a twenty-first embodiment according to the present invention is attached;

FIG. 72 is an end view of the apparatus proper to which the attachment of FIG. 71 is attached,

FIG. 73 is a bottom view of the apparatus proper to which the attachment of FIG. 71 is attached;

FIG. 74 is a side view of the apparatus proper to which the attachment of FIG. 71 is attached;

FIG. 75 is a cross-sectional view taken along a line A-A, and FIGS. 76A and 76B respectively illustrate successive stages of attaching the attachment to the apparatus proper; and FIG. 76C illustrates removal of the attachment from the apparatus proper.

### PREFERRED EMBODIMENT OF THE INVENTION

[First Embodiment]

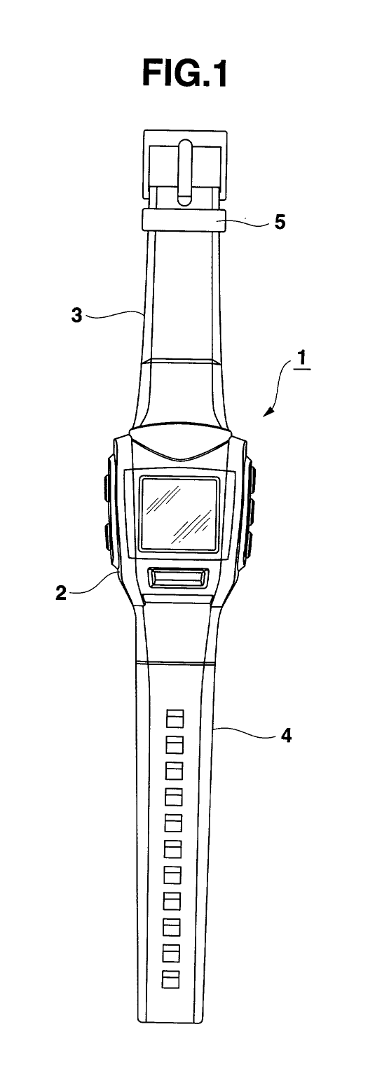

FIG. 1 is a plan view of one embodiment of a whole portable image-pickup apparatus according to the present invention. Reference numeral 1 denotes the whole apparatus; 2 the apparatus proper: 3, 4; a wristband; and 5 a band keeper.

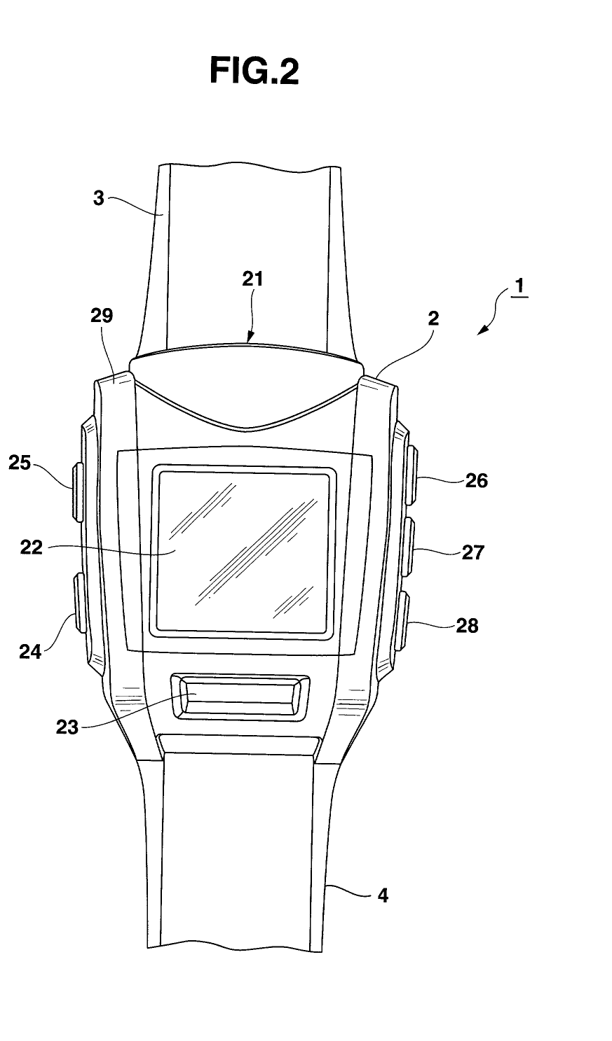

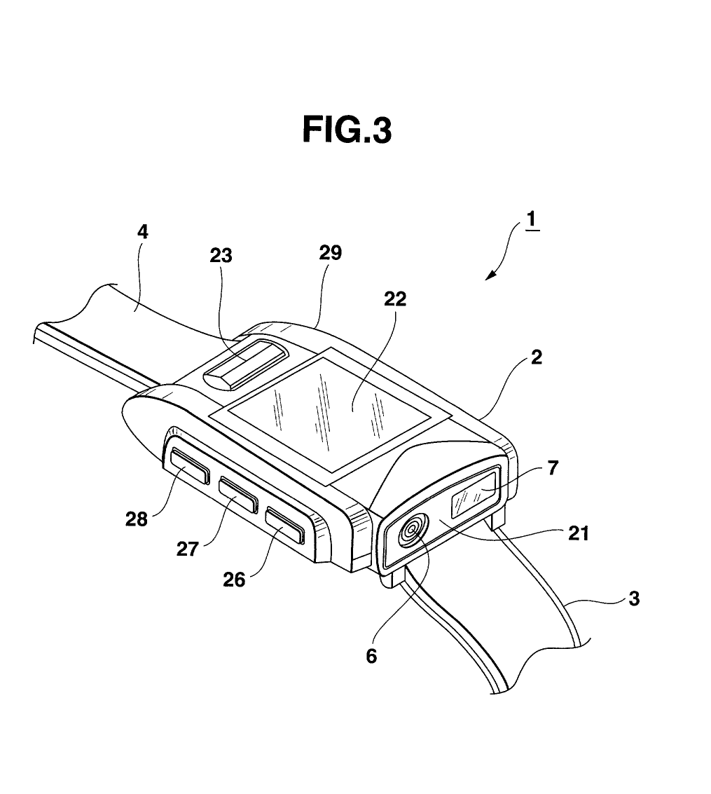

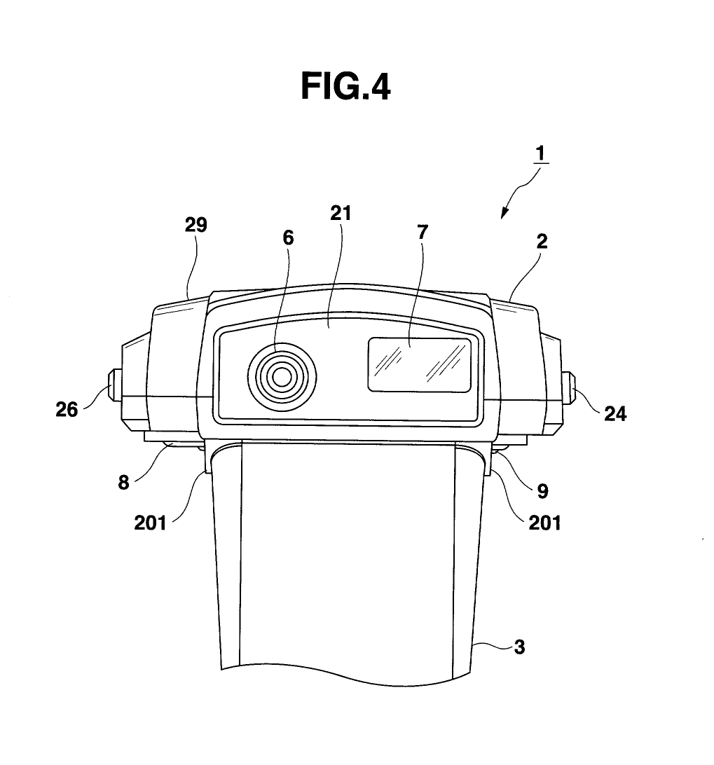

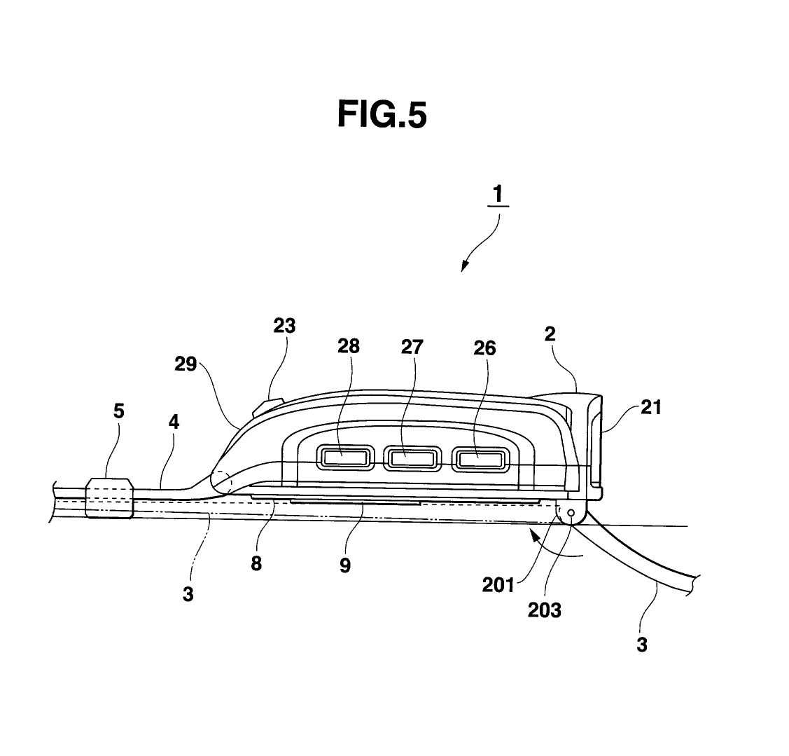

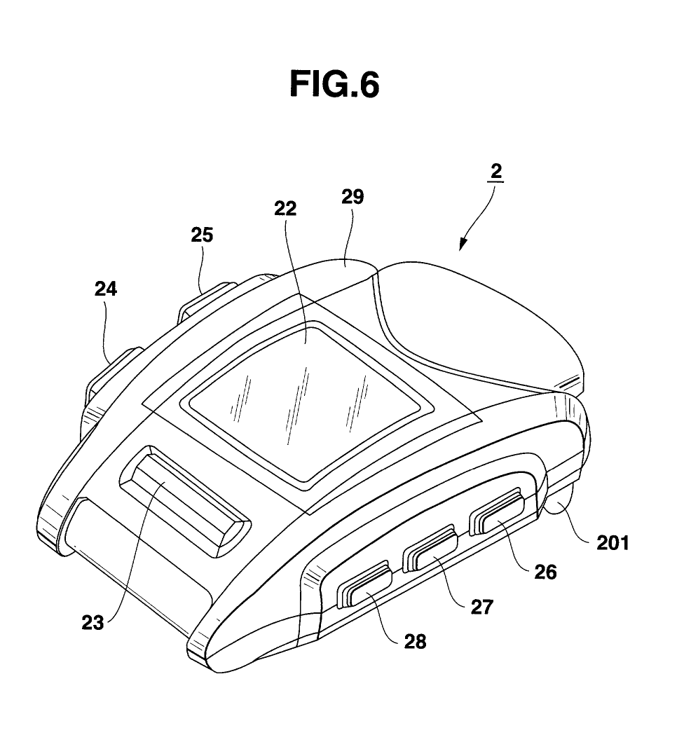

FIG. 1 is a plan view of one embodiment of a wristwatch-type image pickup apparatus according to the present invention. FIG. 2 is an enlarged plan view of the image pickup apparatus proper of FIG. 1. FIG. 3 is a perspective view of the image pickup apparatus proper of FIG. 2. FIG. 4 is a front view of the image pickup apparatus proper of FIG. 3, showing a camera unit and an optical communication unit thereof FIG. 5 is a side view of the apparatus proper of FIG. 4. FIG. 6 is a perspective view of the apparatus portion of FIG. 3, showing the opposite side of the apparatus proper from the camera unit and optical communication unit thereof. Reference numeral 6 denotes an image pickup lens of a camera unit: 7 an infrared (optical) communication unit; 8 back cover, 9 a battery cover; 21 a transparent cover: 22; a data display; 23 a shutter button; 24 an adjust key; 25 a mode key; 26 a reverse key; 27 a display switching key; 28 a forward key; and 29 a bezel.

As shown in FIGS. 3 and 4, the apparatus 1 comprises the image pickup lens 6 and the optical (infrared) communication unit 7 juxtaposed on an end face thereof below which the wristband 3 is attached.

As shown in FIG. 3, the transparent cover 21 covers the lens 6 and the communication unit 7 in common with the data display 22 and the shutter button 23 being provided on the top of the apparatus proper 2. The shutter button 23 is positioned on the opposite side of the data display 22 from the lens 6 and the communication unit 7. When the shutter button 23 is depressed downwards, it gives the apparatus a command to start image pickup.

As shown in FIG. 2, the adjust key 24 and the mode key 25 are provided on one side of the apparatus proper 2 whereas the reverse key 26, the display switching key 27 and the forward key 28 are provided on the other side. The reverse key 26 and the indicator switching key 27 are used to display a plurality of image pickup data on the data display 22 and to give the apparatus a command to switch the display, respectively.

As shown in FIGS. 3-6, the apparatus proper 2 has a pair of band (spring rod) attaching units 201 at a lower end of the end face thereof where the lens 6 and the communication unit 7 appears. The wristband 3 is attached at one end through a pin or spring rod 203 between the pair of band attaching units 201 so as to be turnable to thereby overlap the wristband 3 with the apparatus proper 2, as shown in FIG. 5. The bezel 29 provided on the surface of the apparatus proper 2 serves to absorb shocks that the apparatus proper 2 receives.

A metal back cover 8, which has attached a battery cover 9 thereto, is screwed on a back of the apparatus proper 2, as shown in FIG. 4. The band attaching shaft 203 may be located at a lefter position than the present position thereof in FIG. 5.

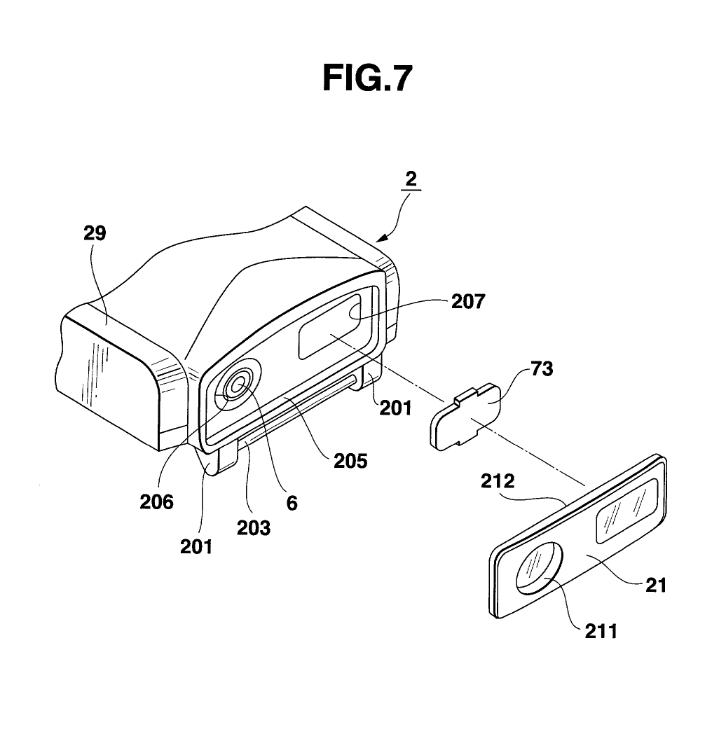

FIG. 7 is a partly decomposed perspective view of the apparatus proper, showing a cover for the lens 6 and the communication unit 7. Reference numeral 73 denotes an infrared communication cover to filter out rays other than the infrared rays. The image pickup lens 6 of the camera unit is disposed in an image pickup window 206 of the apparatus proper 2. The infrared communication unit 7 is disposed in a communication window 207 of the apparatus proper 2. The transparent cover 21 covering the lens 6 and the communication unit 7 in common is received in a recess 205 open in the end face of the apparatus proper 2.

Provided behind the image pickup lens 6 are a CMOS (Complementary Metal-Oxide Semiconductor) sensor (not shown) to sense and convert an optical signal received by the lens to data, and then transfer the data to a relevant unit.

The infrared communication cover 73 is fused to the opening of the communication window 207. In addition, a convex lens-like transparent cover 21 is fused to the cover receiving recess 205 to cover the lens 6 and the communication unit 7 in common. The transparent cover 21 has a circular lens-like recess 211 thereon at a position coinciding with the lens 6 and is covered at its back with a black print 212 except for the image pickup window 206 and the communication window 207.

As will be obvious from the above, the apparatus 1 comprises the image pickup lens 6 and the infrared communication unit 7 juxtaposed on the end face of the apparatus proper 2. Thus, the user can pick up an image of an object by depressing the shutter button 23, and also perform infrared data communication, using the data display 22 as a monitor (or finder) in a state where the apparatus 1 is worn on the user's wrist.

The apparatus can be used to pick up an image of an object and perform data communication when the apparatus proper 2 is placed, for example, on a desk with the wristband 3 being folded under the apparatus proper 2, as shown in broken lines in FIG. 5,. Since the lens 6 and the communication unit 7 are covered with the common transparent cover 21, the number of parts and assembling steps is reduced compared to the case where the common transparent cover 21 is not used.

As described above, the convex transparent cover 21 has the circular recess 211 aligning with the lens 6, and the back covered with the black print 212 except for the image pickup window 206 and the communication window 27. Thus, image pickup by the lens 6 is not optically hindered. The transparent cover 21 fails to adversely affect the lens 6 and the communication unit 7 optically to thereby prevent the optical axes of the lens 6 and the communication unit 7 from interfering with each other.

Arrangement may be such that the transparent cover 21 is made of a filter and that the filter characteristic is reduced by the circular recess 211, instead of providing the infrared communication cover 73.

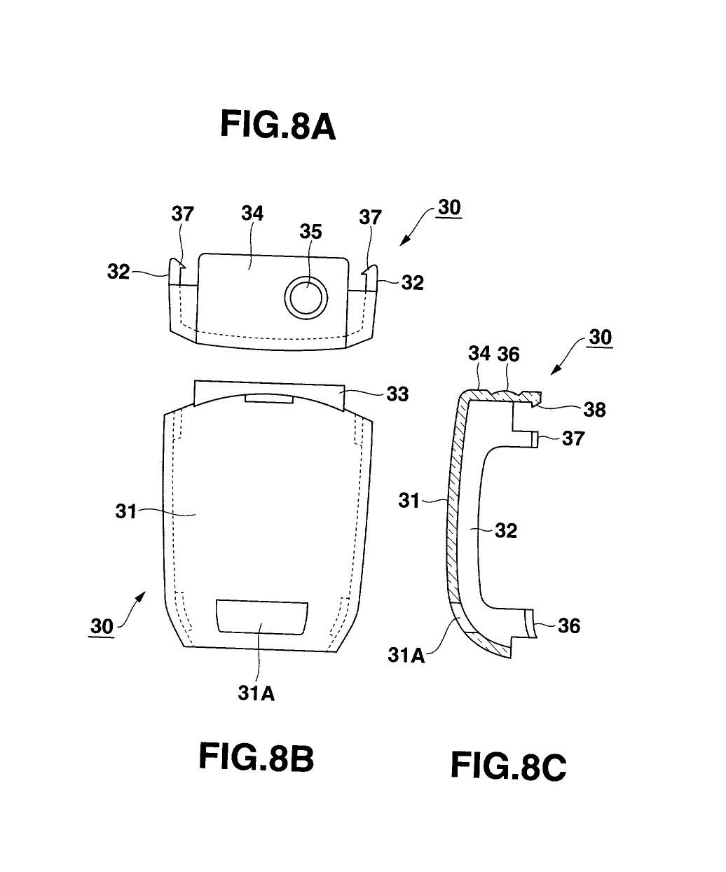

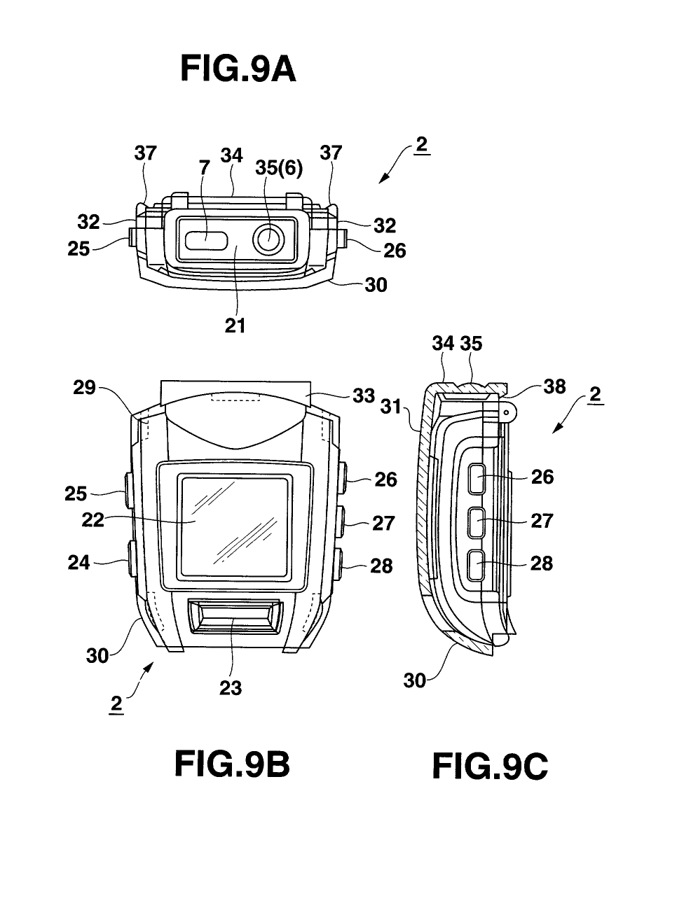

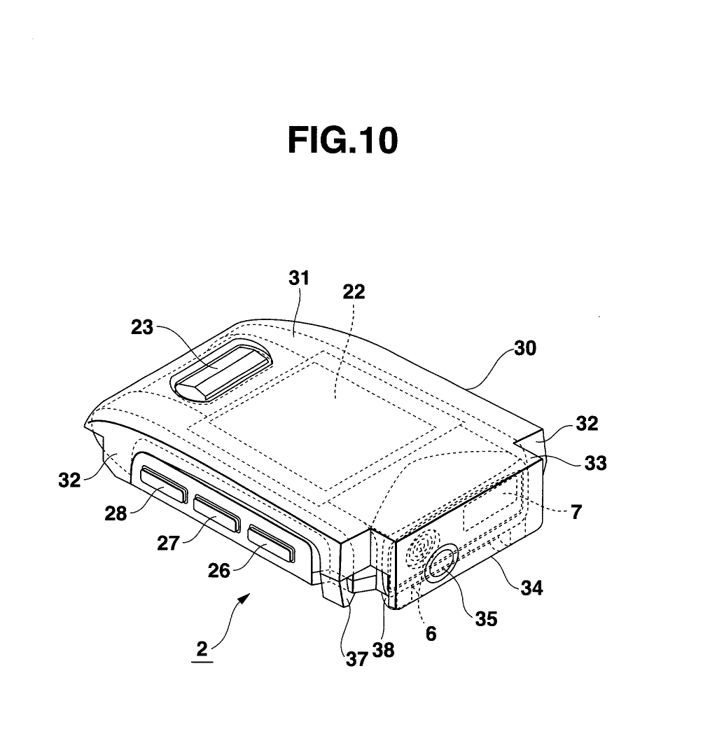

As shown in FIGS. 8A, 8B, 8C; 9A, 9B, 9C; and 10, an attachment 30 comprises a top section 31 that covers the top of the apparatus proper 2, which contains the data display 22 of the apparatus proper 2, right and left sides 32 that cover the corresponding sides of the apparatus proper 2 so as to expose right and left operation buttons 26, 27, 28 and 24, 25 and a protrusion 33 that covers the transparent cover 21 of the apparatus proper 2. The protrusion 33 of the attachment 30 has an end face 34 that has a lens 35 at a position aligning with the image pickup lens 6 to fulfill one of special optical functions including telescopic/wide-angle/micro/various filter functions (color temperature conversion, ultra violet absorption (cut), color tone correction for fluorescent-lamp, light polarization, color tone correction).

The right and left sides of the attachment fitted over the right and left operation buttons 26-28 and 24, 25 share two sets of hooks 36 and 37 protruding inward from lower edges thereof A hook 38 facing inward is provided on a lower edge of the end face 34.

The attachment top 31 has an opening 31A in which the shutter button 23 is exposed.

The attachment 30 is made of a transparent plastic material that comprises the lens 35 and the two sets of hooks 36-38 integral therewith. Alternatively, the attachment 30 may be made of a so-called two-colored molding of a transparent plastic material that covers the lens 35 and the data display 22 and an opaque material that covers the remaining portion of the attachment.

When the attachment 30 is applied to the apparatus proper 2, the right and left sides 32, end face 34 and top 31 of the attachment 30 are placed over the corresponding parts of the apparatus proper 2 with the hooks 36, 37 and 38 being engaged with the back of the apparatus proper 2 on three sides to thereby fix the attachment 30 to the apparatus proper 2. Thus, a lens 35 of another selected attachment 30 provides a corresponding one of the telescopic/wide angle/micro functions/various filtering functions (color temperature conversion, ultra violet absorption (cut), color tone correction for fluorescent-lamp, light polarization, color tone correction).

When no lens 35 is provided in the end face 34 of the attachment 30, the end face 34 may be processed so as to provide a filtering effect, for example, by coloring the end face 34 with a pigment optically transparent to light having a specified wavelength.

The attachment top 31 serves to protect the data display 22 of the apparatus proper 2. Attaching and removing the attachment 30 to and from the apparatus proper can easily be performed by the hooks 36-38.

Provision of the hooks 36-38 integral with attachment 30 prevents an increase in the number of parts used to attach the attachment 30 to the apparatus proper 2 thereby reduce the cost.

If the data display 22 formed on the top 31 of the attachment 30 has a convex lens structure, a display image enlarging effect is produced.

A frame may be printed around the data display 22 on the attachment top 31. In addition, a description about the effects of the lens 35 (×10, UV-filter, etc.) may be printed in the frame. The portion of the attachment 30 that covers the data display 22 may be made so as to take the form of a covenx lens from a material similar to that of lens 35 so that the user can confirm through the data display 22 an image having an optical image pickup effect similar to that produced by the lens 35.

[Second Embodiment]

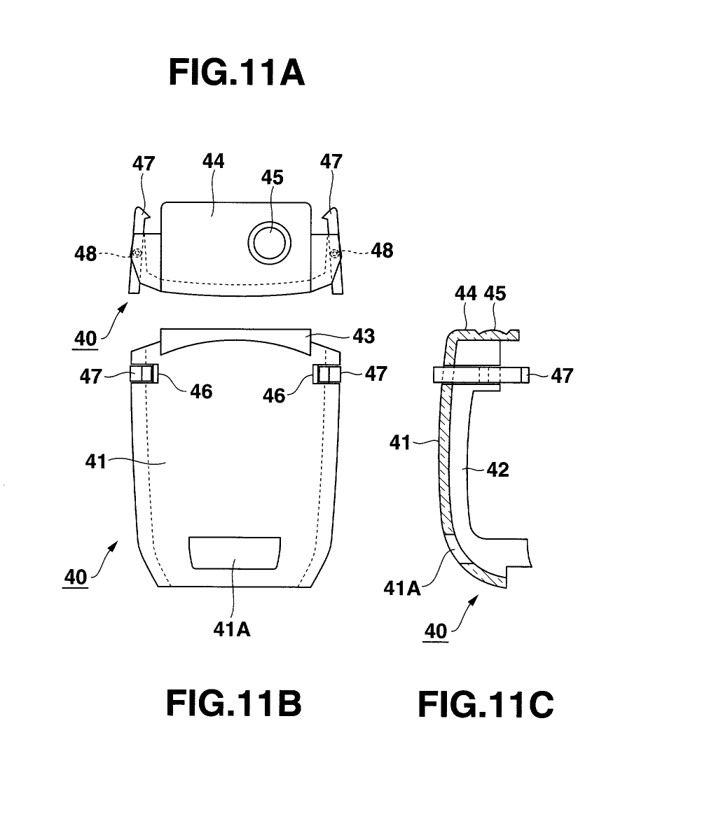

As shown in FIGS. 11A, 11B and 11C, attachment 40 has top 41 with opening 41A, right and left sides 42, protrusion 43 with an end face 44, and lens 45 as in the first embodiment. The attachment 40 is made of a transparent or two-colored plastic molding.

The attachment 40 has a pair of cuts 46 into which a pair of hook levers 47 are received, respectively. Each hook lever 47 is biased by a spring 48 so that the hook lever 47 turns inward at its upper end.

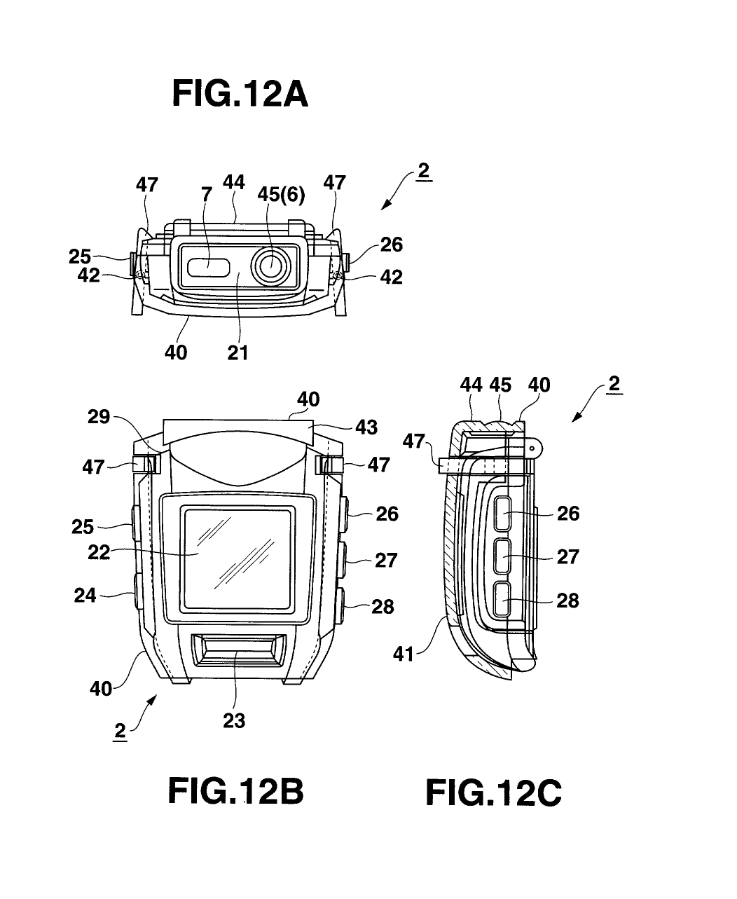

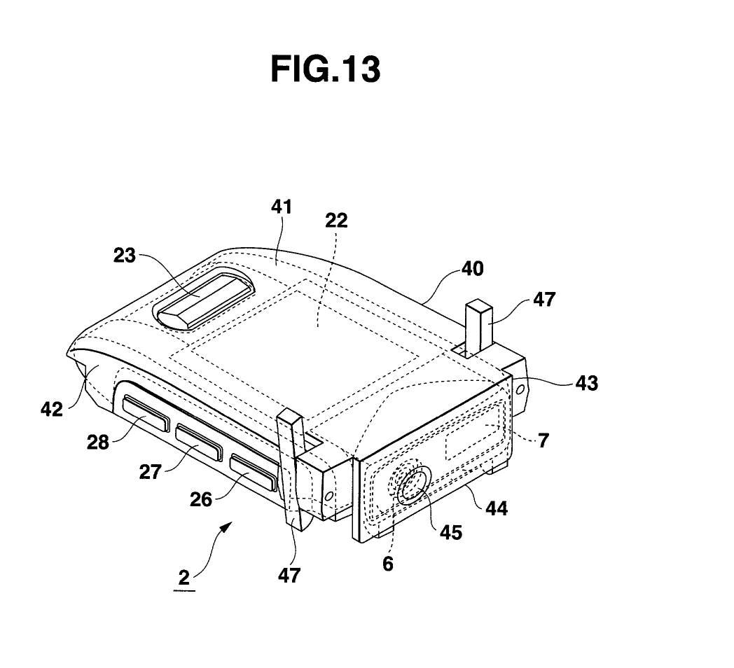

FIGS. 12A, 12B, 12C and 13 show the attachment 40 attached to the apparatus proper 2 so that its top covers the top of the apparatus proper 2 and that the right and left sides 44 and 42 of the attachment 40 cover the corresponding sides of the apparatus proper 2. The pair of hook levers 47 each provided on the respective one of the right and left sides of the attachment engages at its hook with the back of the apparatus proper 2 to thereby fasten the attachment 40 to the apparatus proper 2.

When attachment 40 is to be removed from the apparatus proper 2, the user moves the pair of levers 47 toward each other at their lower ends. This causes the pair of hook levers 47 to move away from each other at their upper ends from the back of the apparatus proper 2.

The pair of hook levers 47 is engaged with the back of the apparatus proper 2 through the corresponding springs 48. Thus, the pair of hook levers 47 has high durability. In addition, when the attachment 40 is to be attached to and removed from the apparatus proper 2, the apparatus proper 2 is rarely hurt, advantageously.

[Third Embodiment]

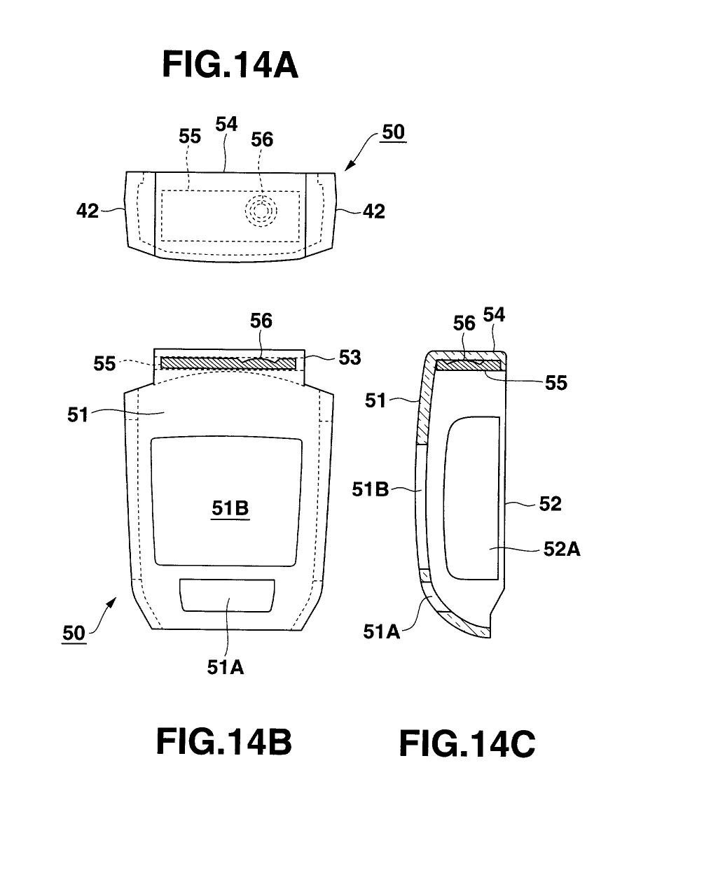

As shown in FIGS. 14A, 14B and 14C, attachment 50 comprises top 51, right and left sides 52, and protrusion 53 with an end face 54. The attachment 50 is made of a transparent plastic material. The attachment 50 has an opening 51A in its top 51 in which shutter button 23 is exposed, and a window 51B in which data display 22 is exposed.

Each side 52 of the attachment 50 has an opening 52A in which a corresponding one of raised side portions 29A of the apparatus proper with operation buttons 24, 25 (or 26-28) is engaged.

A transparent plastic plate 55 having an image enlarging lens 56 is received within attachment protrusion 53.

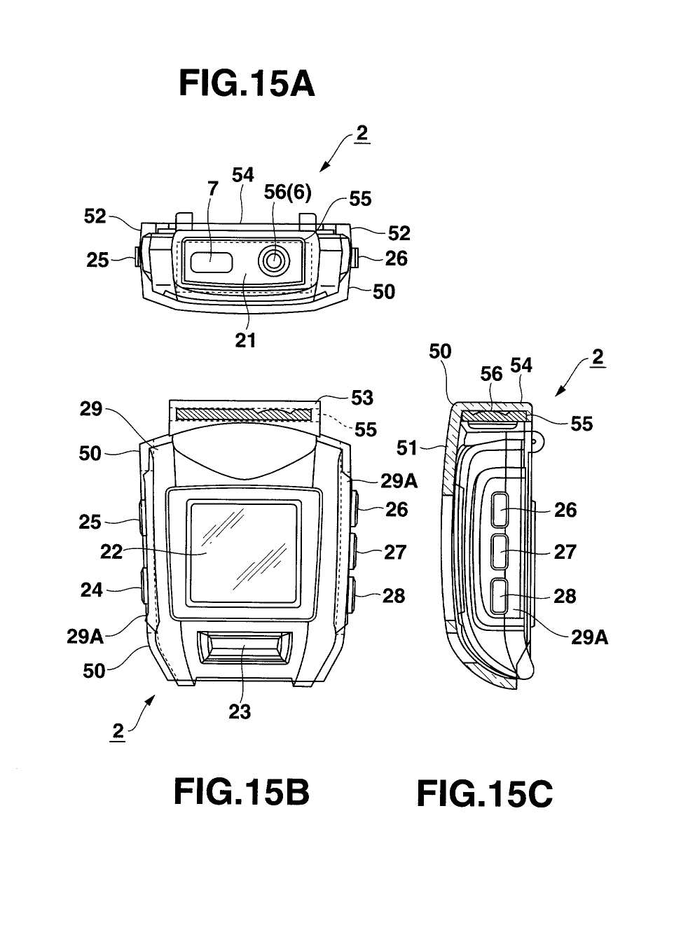

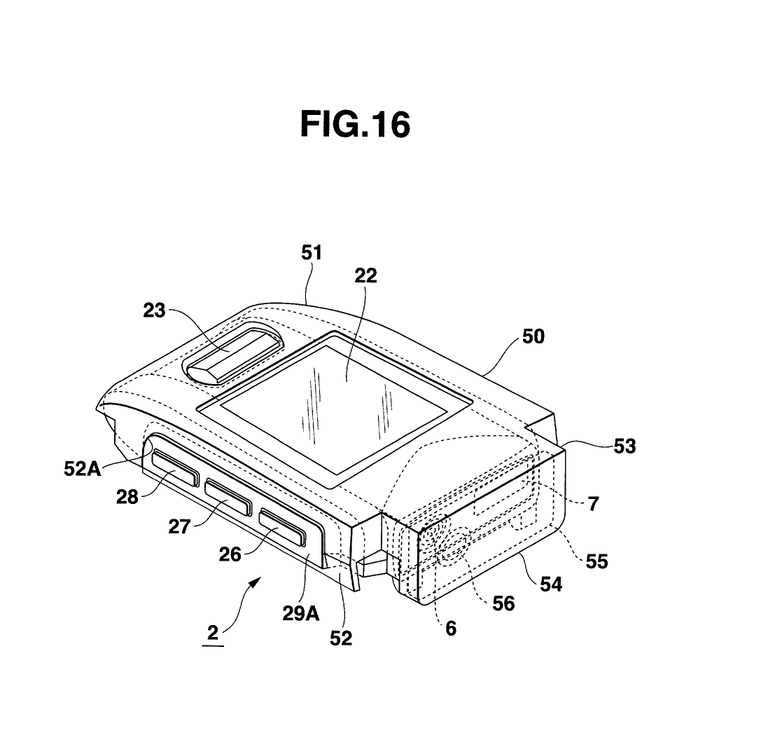

FIGS. 15A, 15B, 15C and 16 show the attachment 50 set on the apparatus proper 2. Each side 52 of the attachment 50 has an opening 52A in which a corresponding one of raised side portions of the apparatus proper with operation buttons 24, 25 (or 26-28) is engaged. Thus, attachment 50 can easily be attached to, or removed from, the apparatus proper 2.

Provision of holes 52A in the respective sides of the attachment 50 prevents the number of parts for attaching attachment 50 to the apparatus proper 2 from increasing to thereby increase the productivity of the maker and attached The right and left raised portions 29a of the apparatus proper 2 are engaged in the holes 52a in the attachment 50 to thereby prevent the apparatus proper 2 from being hurt when removed.

[Fourth Embodiment]

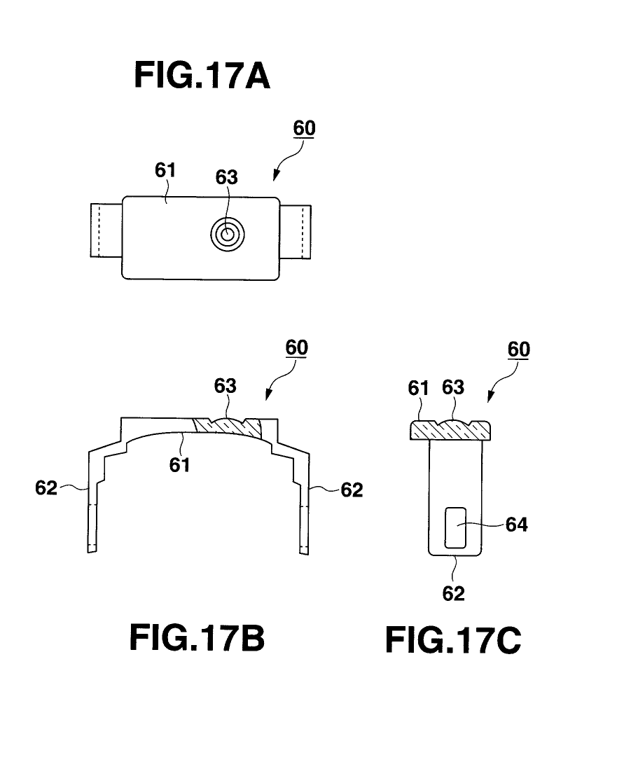

As shown in FIGS. 17A, 17B and 17C, attachment 60 comprises a front 61 covering transparent cover 21 of the apparatus proper 2, and right and left sides 62 having holes 64 in which operation buttons 25 and 26 of the apparatus proper 2 are engaged. The attachment 60 is made of a transparent plastic material. The front 61 has an image enlaring lens 63.

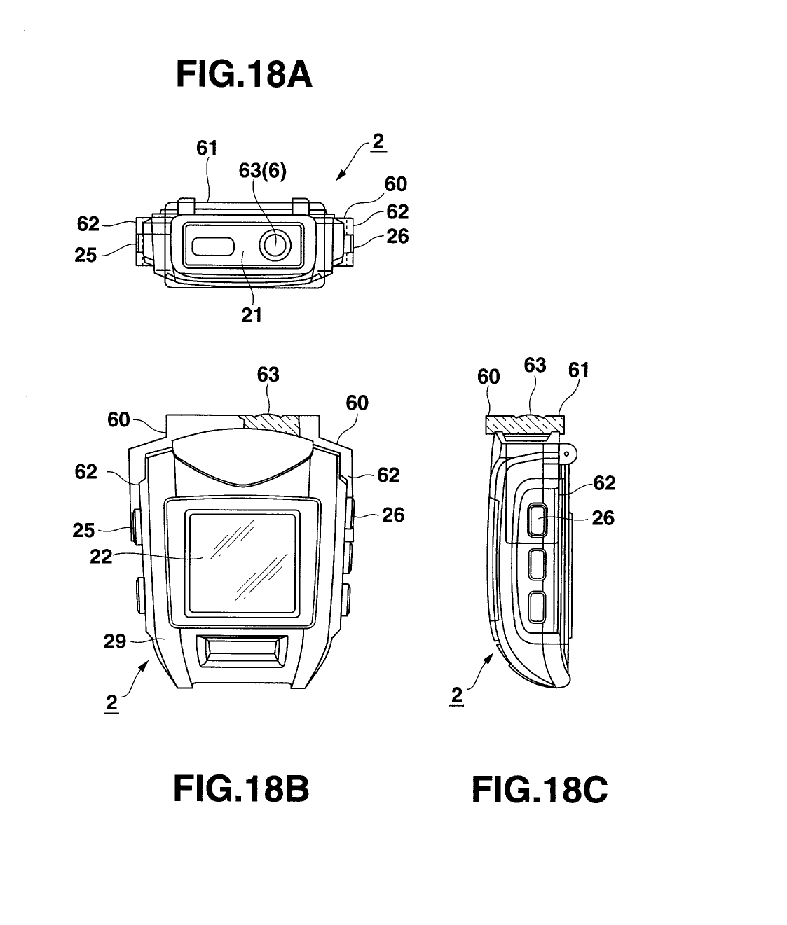

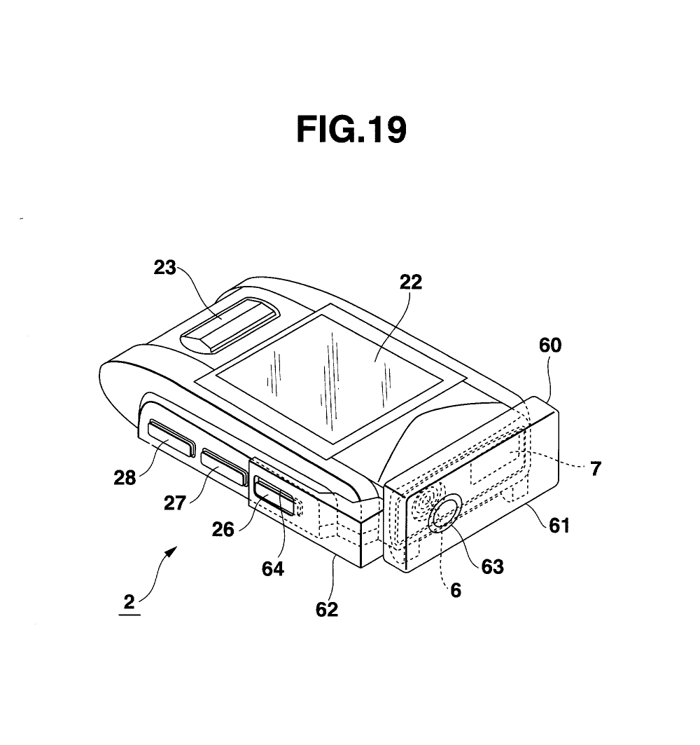

FIGS. 18A, 18B, 18C and 19 show the attachment 60 fitted over the apparatus proper 2. Attachment 60 is attached to the apparatus proper 2 by engaging operation buttons 25 and 26 of the apparatus proper 2 in holes 64 in the attachment 60.

As described above, the attachment 60 comprises only front section 61 having lens 63 and fastening sides 62 to thereby produce advantageous effects similar to those produced by the third embodiment. Thus, attachment 60 is reduced in size.

[Fifth Embodiment]

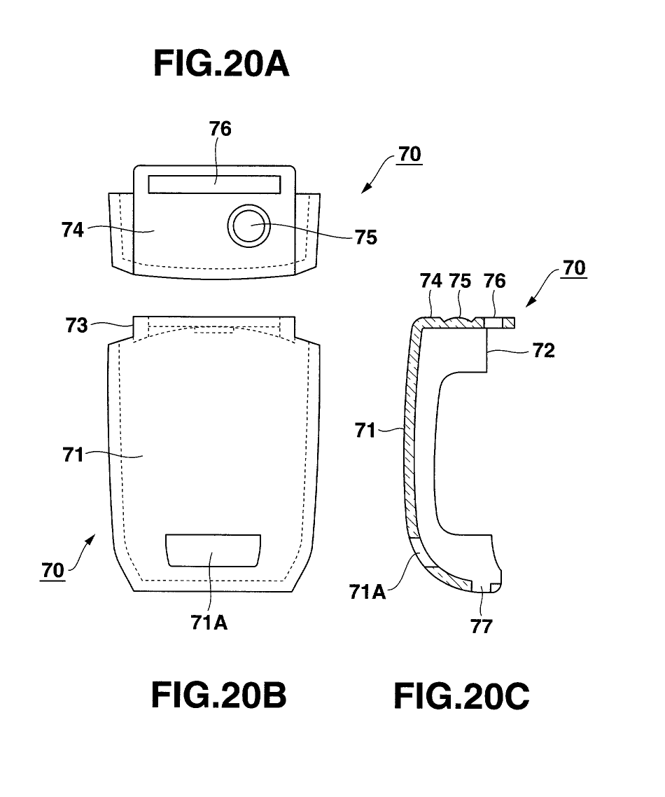

As shown in FIGS. 20A, 20B and 20C, attachment 70 has top 71 with hole 71A, right and left sides 72, 74, protrusion 73 and lens 75, like the second embodiment. The attachment 70 is made of a transparent or two-colored plastic molding.

The fifth embodiment is different from the fourth one in that the former attachment 70 has a band insert hole 76 in its end face 74, and another band insert hole 77 in an opposite end of the attachment 70 from band insert hole 76.

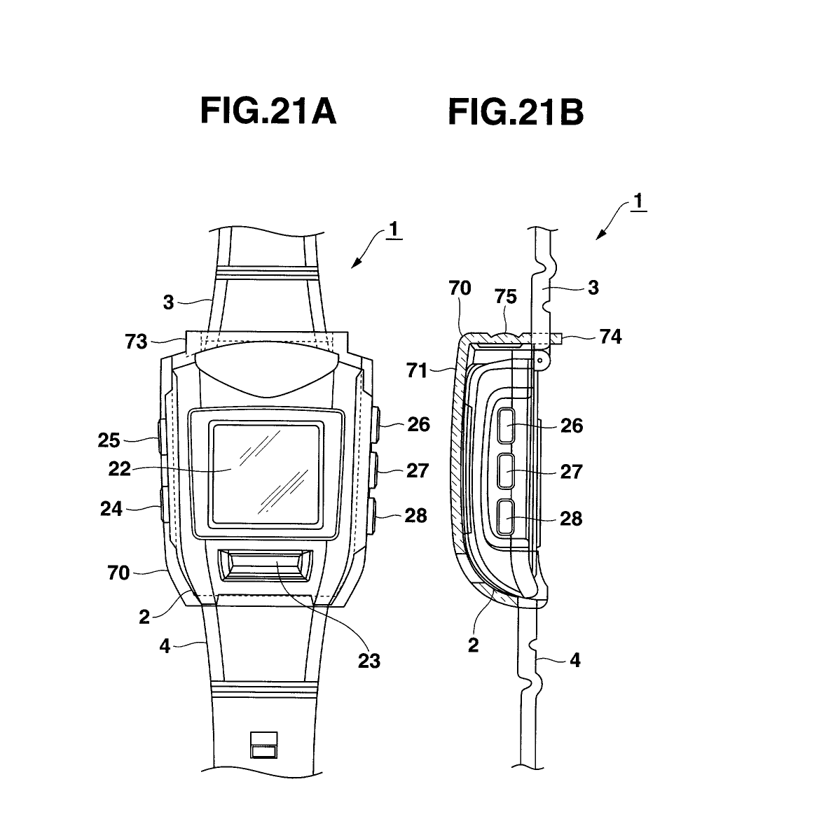

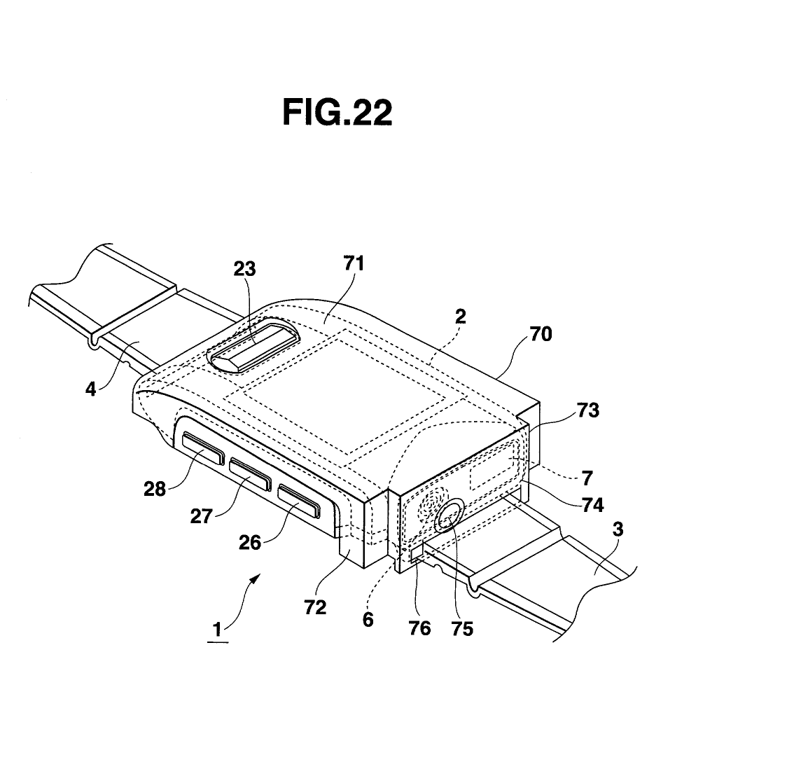

FIGS. 21A, 21B and 22 show the attachment 70 fitted over the apparatus proper 2. Wristbands 3 and 4 are inserted at one end into band insert holes 76 and 77, respectively, to thereby fasten the attachment 70 to the apparatus proper 2. Thus, in addition to the various advantageously effects produced by the above embodiments, the attachment 70 produces an advantages effect that it is difficult to slip from the apparatus proper 2.

[Sixth Embodiment]

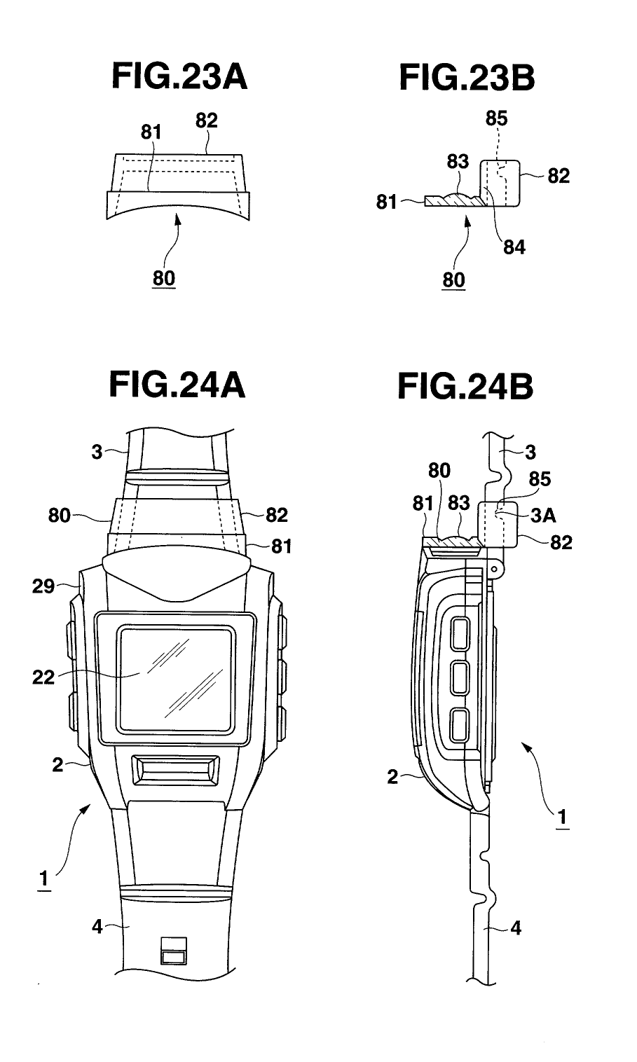

As shown in FIGS. 23A and 23B, attachment 80 comprises a front 81 covering the transparent cover 21 of the apparatus proper 2 and a fixing section 82 extending from a lower end of the front 81. The attachment 80 is made of a transparent material The front 81 has an image enlarging lens 83. The fixing section 82 has a band insert hole 84 in which a positioning protrusion 85 is formed.

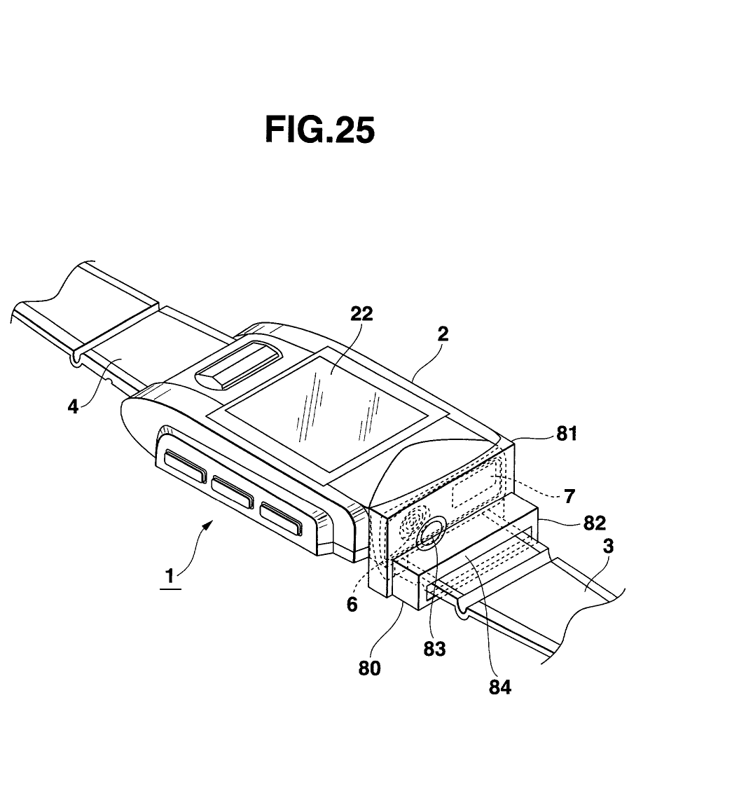

FIGS. 24A, 24B and 25 show the attachment 80 fitted over the apparatus proper 2. The attachment 80 is attached to the apparatus proper 2 by inserting wristband 3 at one end into the band insert hole 84 in fixing section 82 and engaging positioning protrusion 85 in a groove 3a of the wristband 3.

Thus, the attachment 80 is fastened only by the wristband 3 to the apparatus proper 2 to thereby reduce the attachment 80 in size.

[Seventh Embodiment]

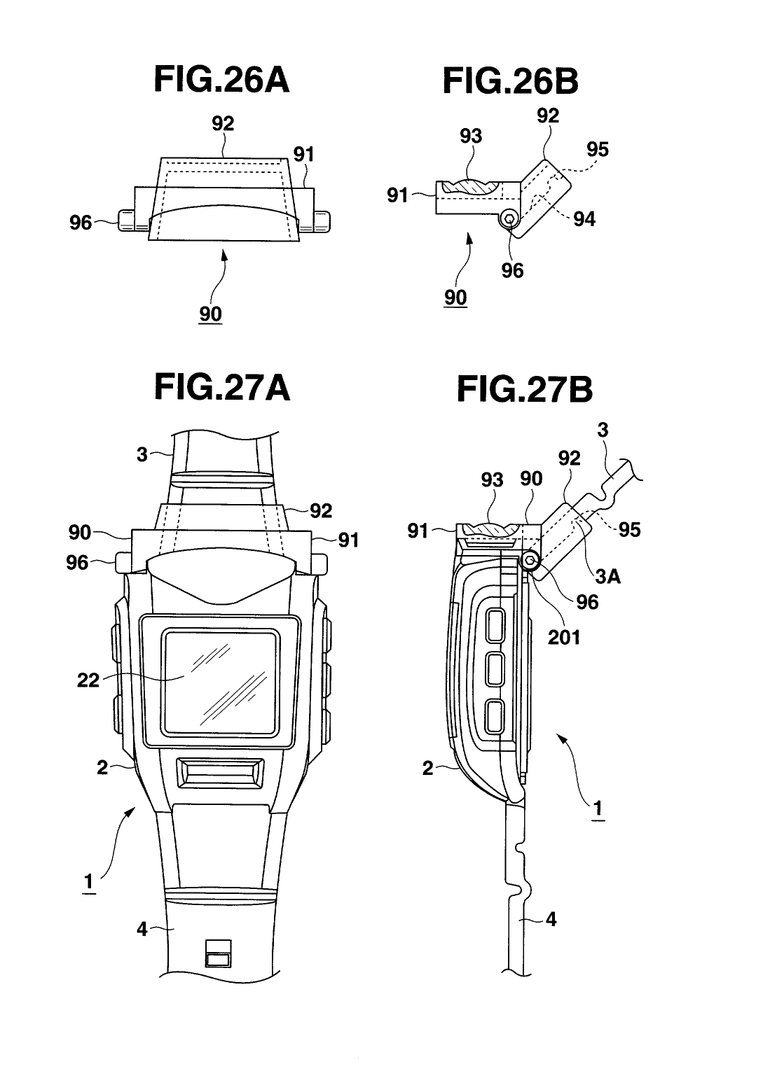

As shown in FIGS. 26A and 26B, attachment 90 comprises front 91 having image enlarging lens 93, and a fastener 92 having a band insert hole 94 with a band positioning protrusion 95 therein. Front 91 and the fastener 92 are coupled rotatably around pairs of bolts 96. Front 91 is made of a transparent plastic material.

The pair of bolts 96 each has an inward extending protrusion (not shown) engaged in a respective one of holes (not shown) in band attaching units 201 of the apparatus proper 2 between which a band attaching shaft (spring rod) 203 is received. The bolts 96 act as a rotational shaft and also as a joint for both the apparatus proper 2 and the attachment 90. Thus, the bolts 96 may have a press-fit structure.

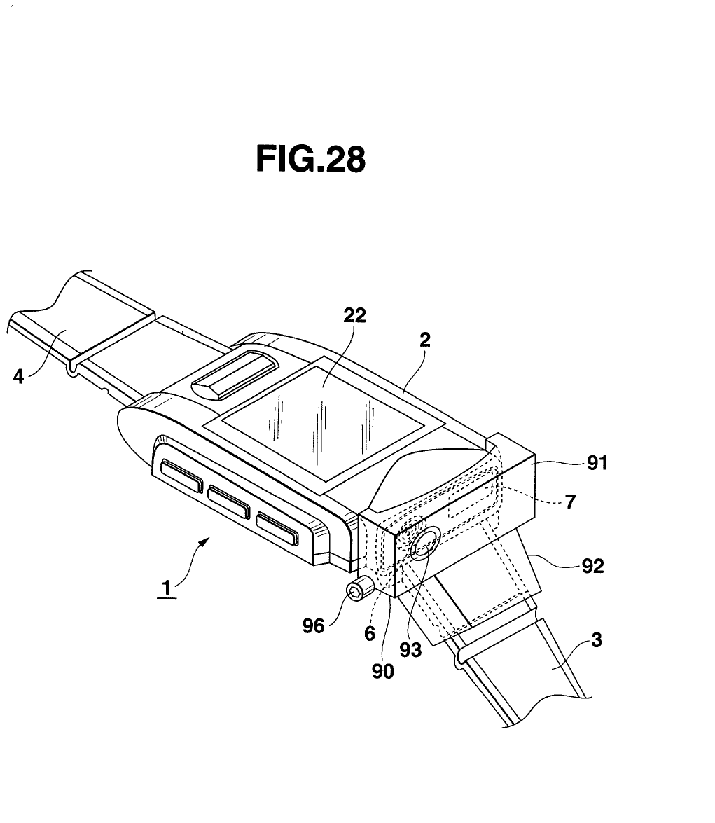

FIGS. 27A, 27B and 28 show the attachment 90 fitted over the apparatus proper 2. As in the sixth embodiment, the attachment 90 is fastened to apparatus proper 2 by inserting wristband 3 at one end into the band insert hole 94, engaging the positioning protrusion 95 in a groove 3a in the wristband 3, and engaging the bolts 96 in the holes in the band attaching units 201.

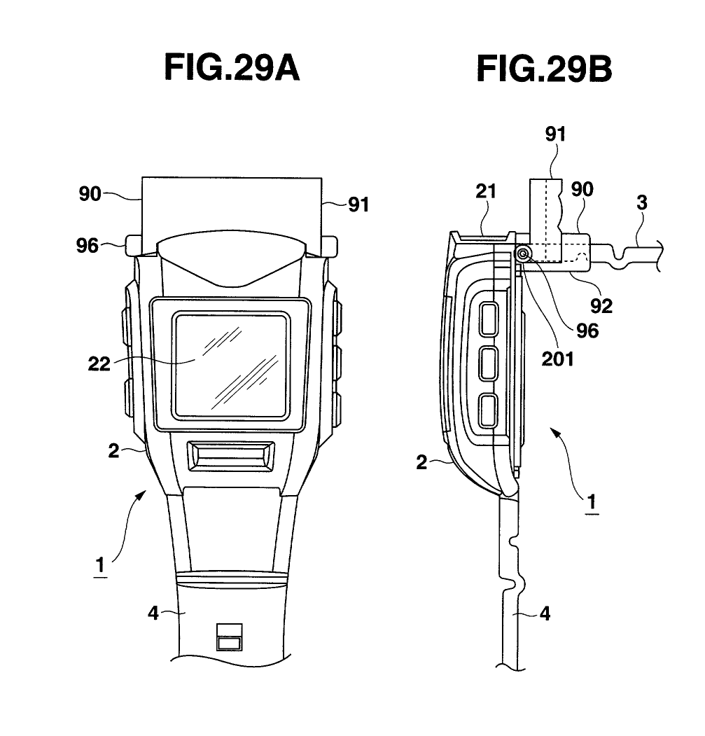

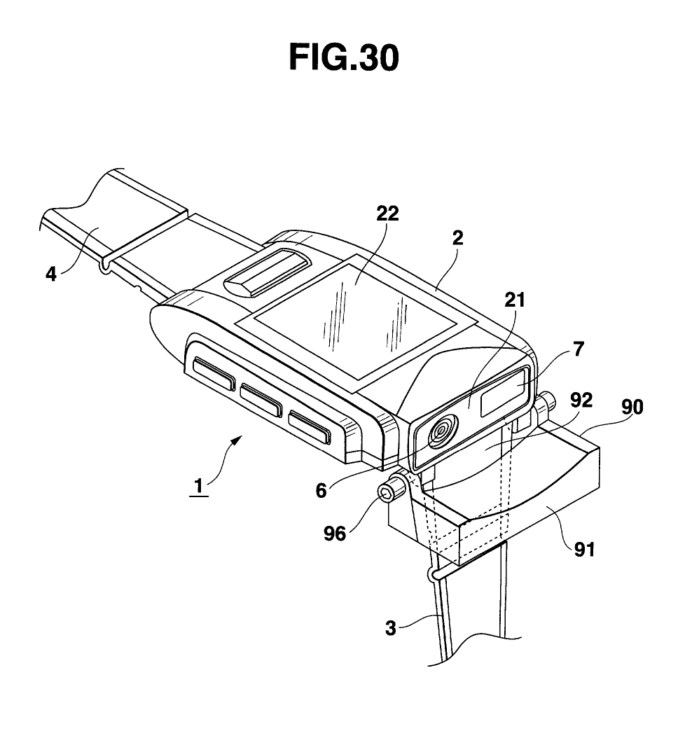

FIGS. 29A, 29B and 30 show the apparatus with the attachment 90 and hence front 91 being turned around the band attaching shaft 203 through 90 degrees relative to the apparatus proper 2 so as to move away from the transparent cover 21 that contains the lens 6. Thus, the user can pick up an image of an object in an ordinary manner without removing the attachment 90 from the apparatus proper 2.

[Eighth Embodiment]

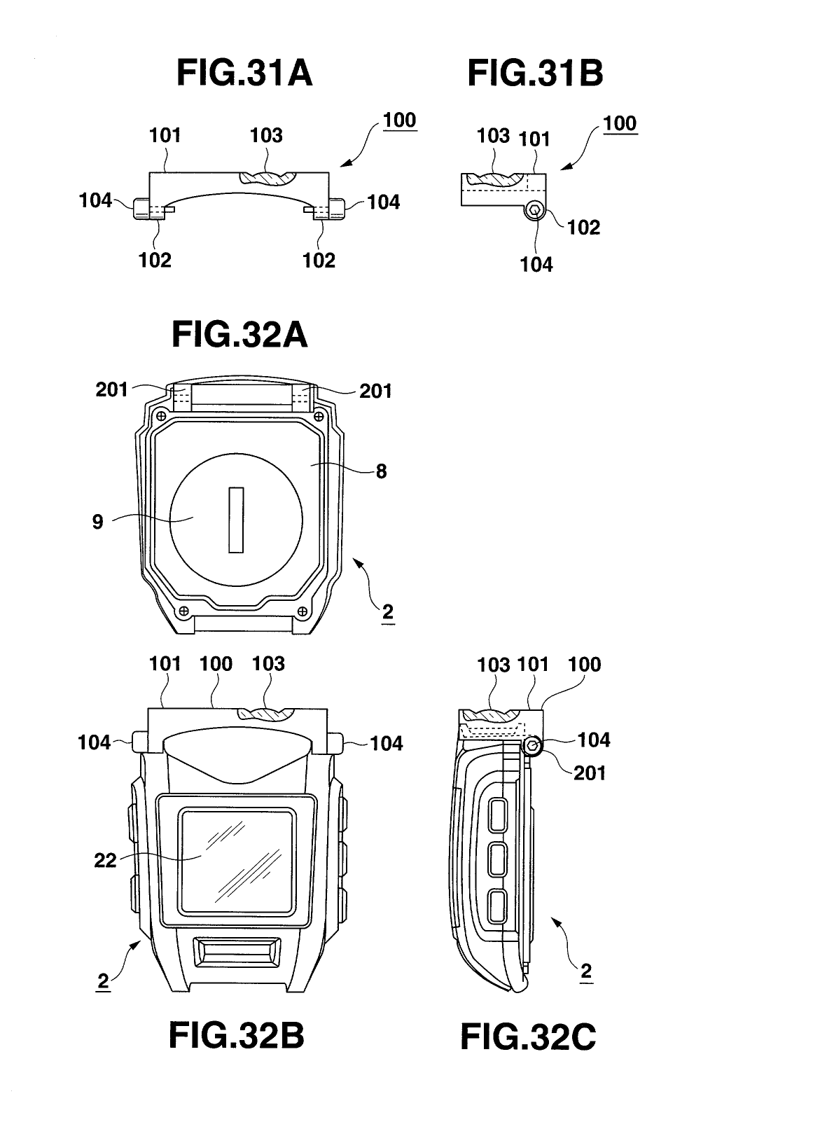

As shown in FIGS. 31A and 31B, attachment 100 comprises front 101 having an image enlarging lens 103, and a pair of supports 102 each protruding from a respective one of sides of the front 101. The attachment 100 is made of a transparent plastic material. The pair of supports 102 each have an inward extending driven pin 104.

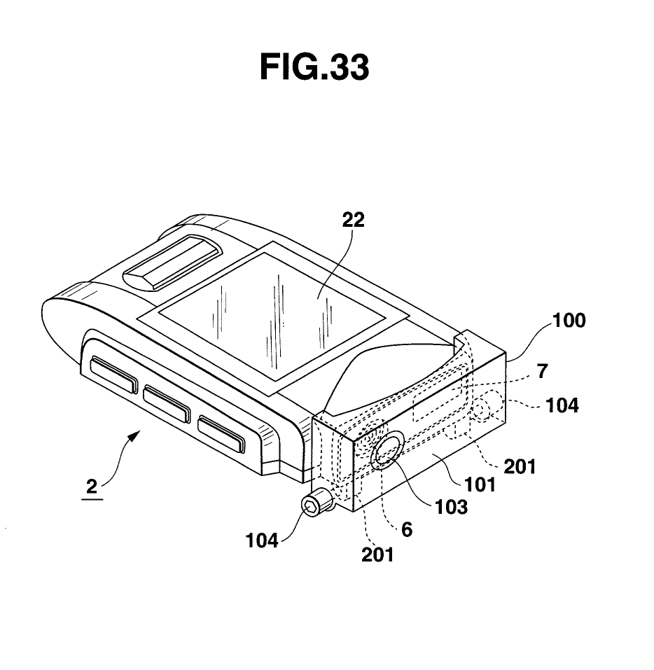

FIGS. 32A, 32B, 32C and 33 show the attachment 100 fitted over the apparatus proper 2. The attachment 100 is fastened to the apparatus proper 2 by driving the pair of driven pins 104 into the holes in the band attaching shaft (spring rod) 203 received in the band attaching units 201 of the apparatus proper 2. This serves to reduce the attachment 100 in size.

[Ninth Embodiment]

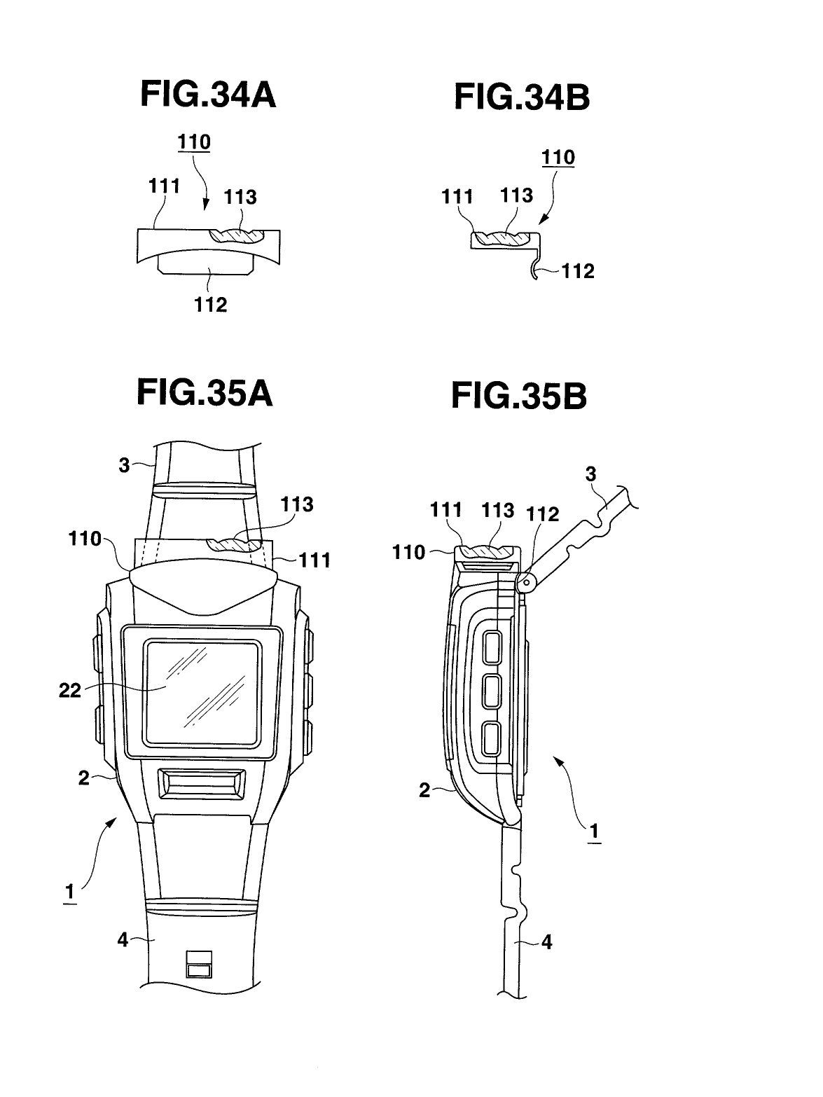

As shown in FIGS. 34A and 34B, attachment 110 comprises front 111 having an image enlarging lens 113 and a tongue 112 extending from a lower end of the front 111. The attachment 110 is made of a transparent plastic material.

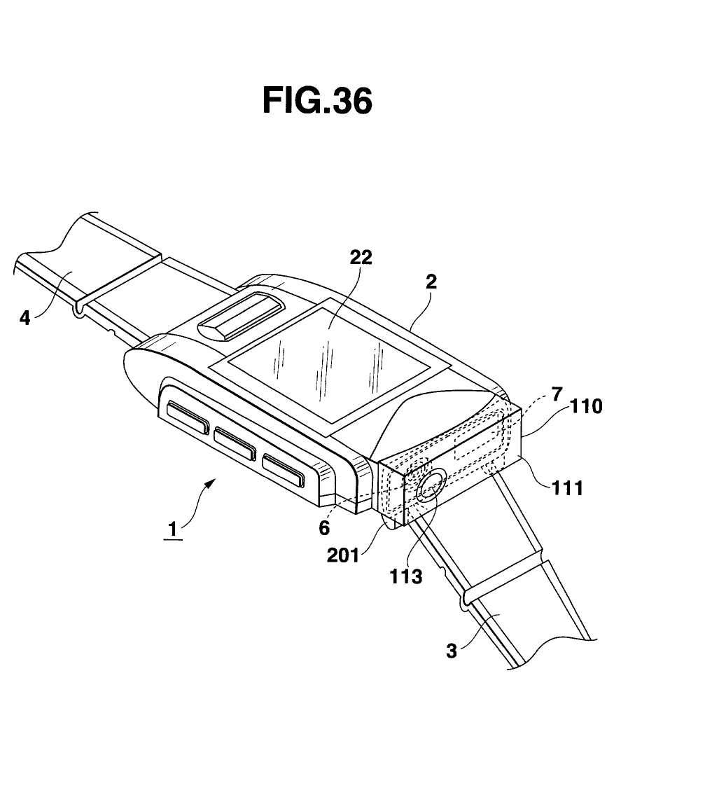

FIGS. 35A, 35B and 36 show the attachment 110 fitted over and fixed to the apparatus proper 2 by inserting the tongue 112 into a gap between the apparatus proper 2 and the wristband 3. When the attachment 110 is to be removed from the apparatus proper 2, the user is required to extract the tongue 112 from the gap.

As described above, according to the present embodiment, the user can easily attach and extract the attachment 110 to and from the apparatus proper 2. The attachment 110 is reduced in size, advantageously.

[Ninth Embodiment]

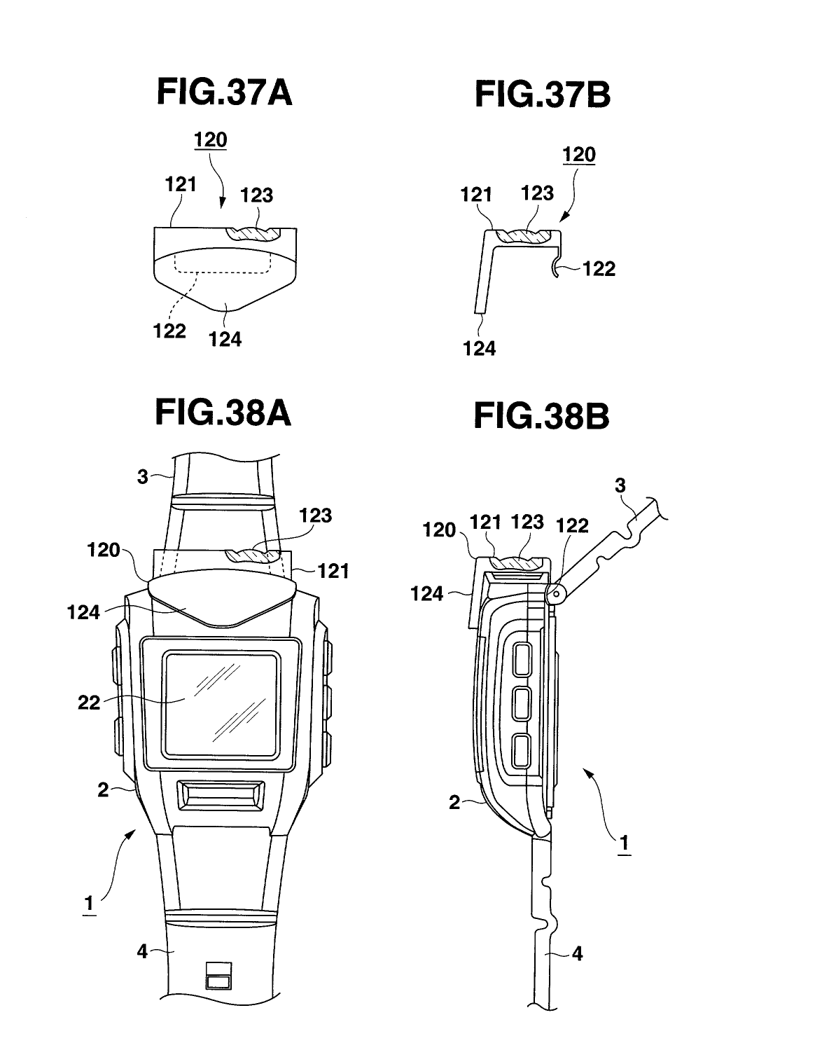

As shown in FIGS. 37A and 37B, attachment 120 comprises front 121 having an image enlarging lens 123, a lower tongue 122 extending from a lower end of the front 121, and an upper tongue 124 extending from an upper end of the front 121, like the ninth embodiment. The attachment 120 is made of a transparent plastic material.

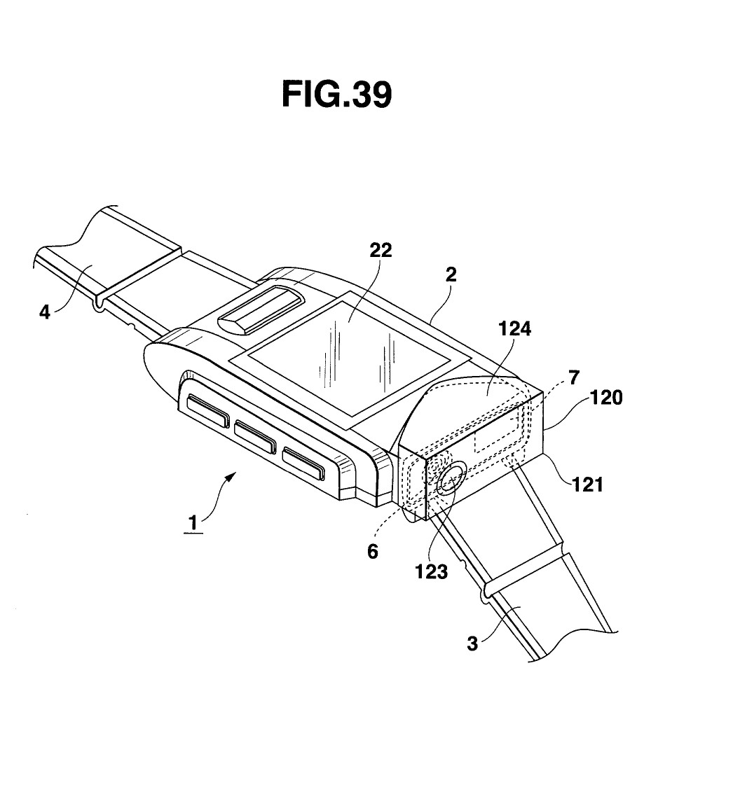

FIGS. 38A, 38B and 39 show the attachment 120 fitted over the apparatus proper 2. The attachment 120 is fastened stably to the apparatus proper 2 by fitting the upper tongue 124 over the top of the apparatus proper 2, and inserting the tongue 122 into a gap between the apparatus proper 2 and the wristband 3.

When the attachment 120 is to be removed from the apparatus proper 2, the user is required to extract the lower tongue 122 from the gap.

As described above, by holding the apparatus proper 2 between the upper and lower tongues 124 and 122 of the attachment 120, attachment 120 is stably attached to the apparatus proper 2.

[Eleventh Embodiment]

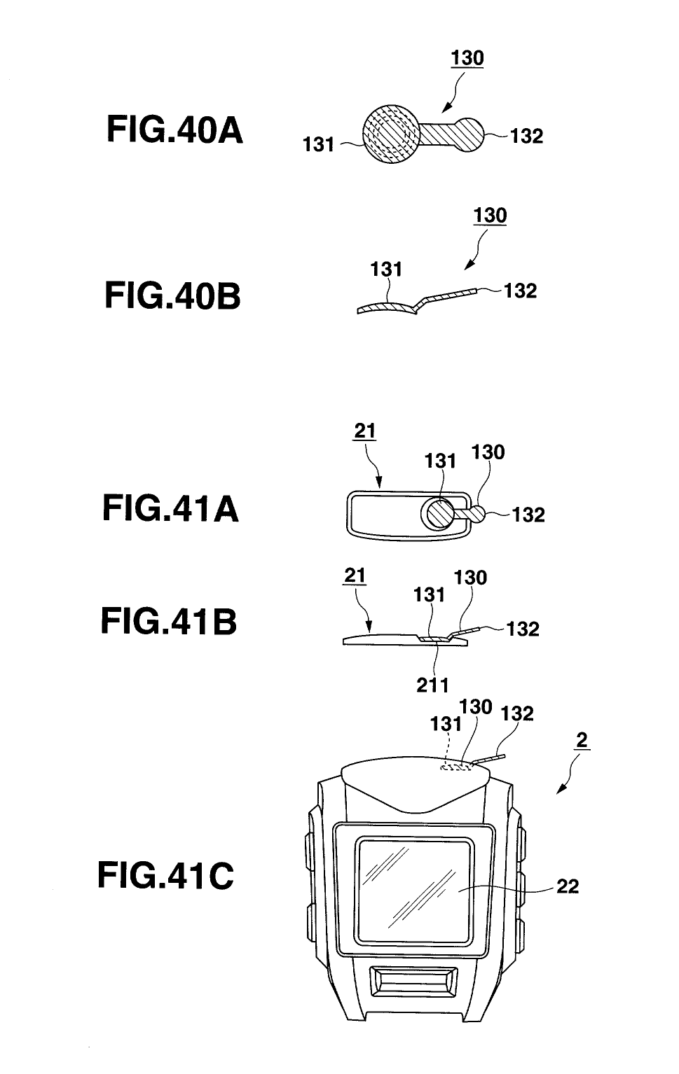

As shown in FIGS. 40A and 40B, attachment 130 comprises an image enlarging lens 131 that can also act as a suction cup, and a separation tab 132 extending from the lens 131. The attachment 130 is made of a soft transparent plastic material.

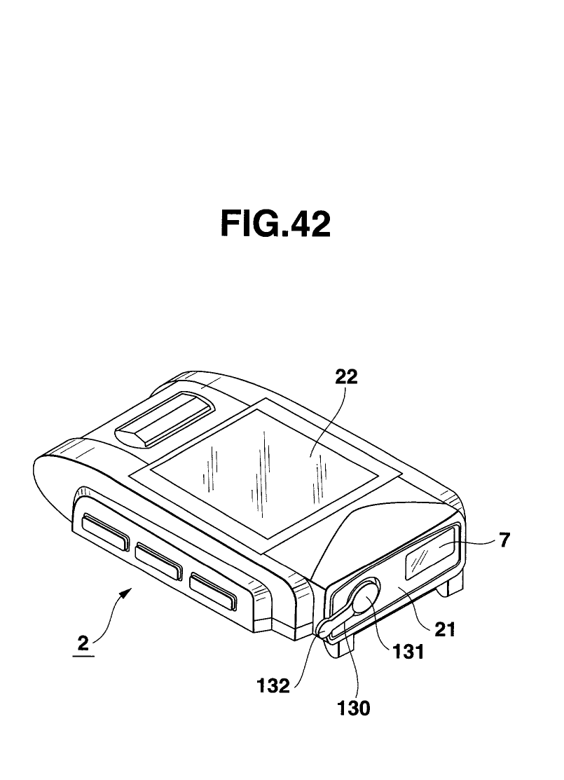

FIGS. 41A, 41B, 41C and 42 show the attachment 130 fitted over the apparatus proper 2 (more particularly, into a circular recess 211), by causing the circular recess 211 to suck lens 131.

When the attachment 130 is to be removed from the apparatus proper 2, the user is required to pull the separation tab 132 away from the cover 21 to move the lends 131 from the cover 21.

Thus, according to this embodiment, the attachment 130 can easily be attached to and removed from the apparatus proper 2 and function as a minimum-sized one among all the above embodiments.

[Twelfth Embodiment]

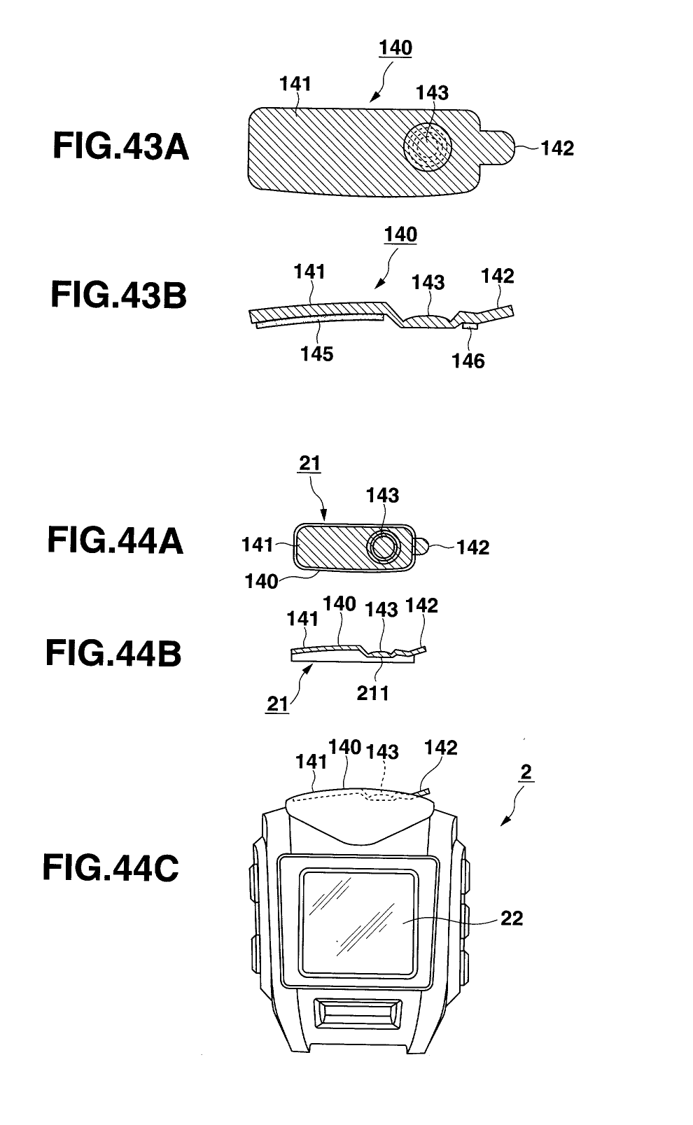

As shown in FIGS. 43A and 43B, attachment 140 comprises front 141 aligning with the transparent cover 21 of the apparatus proper 2, and a separation tab 142 extending outward from a side of the front 141. The attachment 140 is made of a soft transparent plastic material. Front 141 has an image enlarging lens 143 that aligns with the circular recess 211 in the transparent cover 21. Pieces of pressure sensitive adhesive double-coated tape 145 and 146 are pasted in position on a back of the front 141 excluding the lens 143.

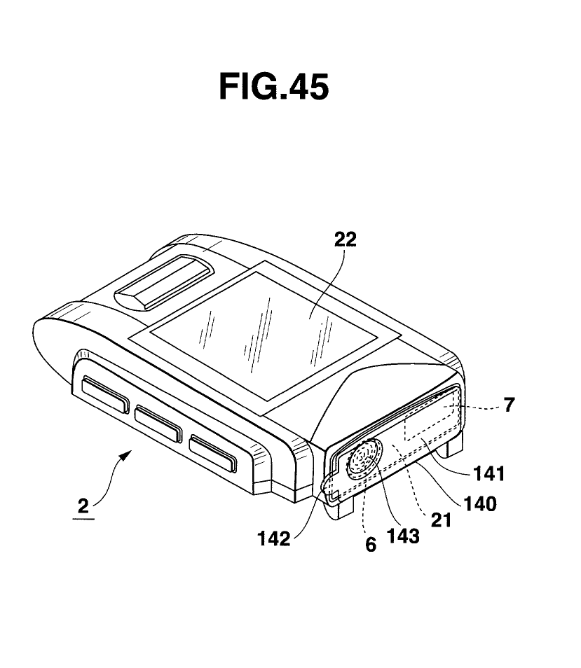

FIGS. 44A, 44B, 44C and 45 show the attachment 140 fitted over the apparatus proper 2 (transparent cover 21) by fitting the lens 143 into the circular recess 211, and pasting the front 141 to the transparent cover 211 with the tape pieces 145 and 146.

When the attachment 140 is to be removed from the apparatus proper 2, the user is required to pull the tab 142 so that the front 141 is moved away from the transparent cover 21.

Thus, according to this embodiment, the attachment 140 can easily be attached to and removed from the apparatus proper 2 and function as a minimum-sized one among all the above embodiments.

[Thirteenth Embodiment]

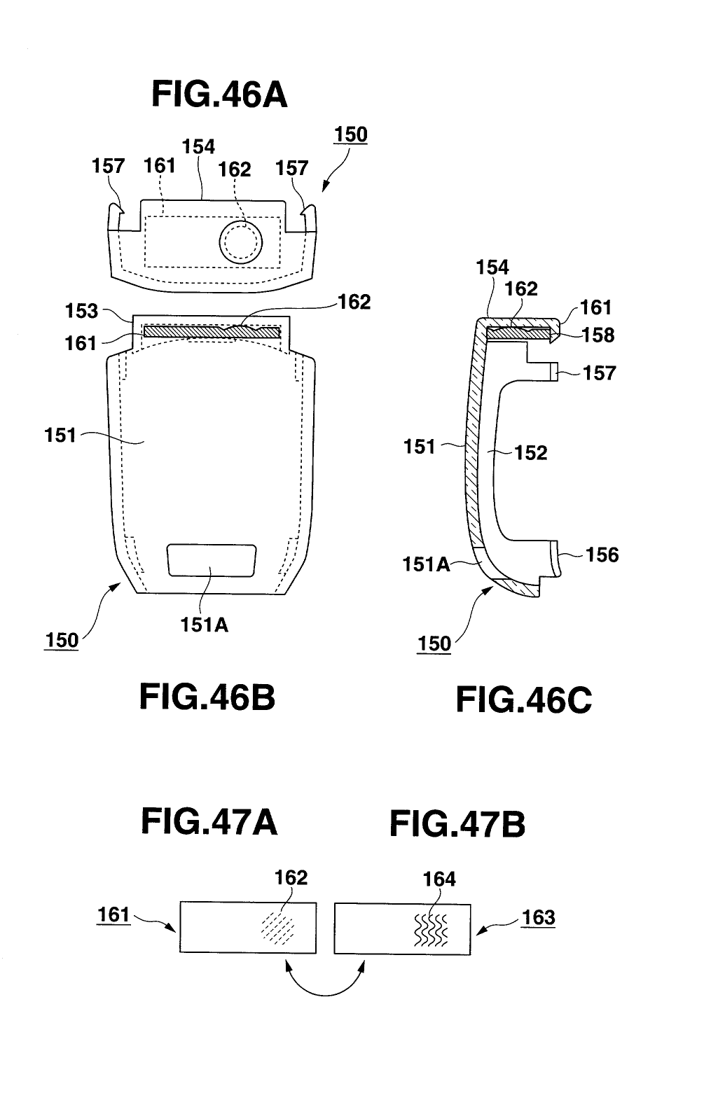

As shown in FIGS. 46A, 46B and 46C, attachment 150 comprises top 151 having a hole 151A, right and left sides 152, protrusion 153, and two pairs of hooks 156 and 157 shared by the right and left sides 152, and an end hook 158. The attachment 150 is made of a transparent or two-colored plastic molding.

As shown in FIG. 47A, a transparent plastic plate 161 having a telescopic lens 162 that produces a telescopic effect “A” is received within the protrusion 153. As shown in FIG. 47B, transparent plastic plate 163 having an optical filter 164 that produces a filtering effect “B” is prepared so as to be set within the protrusion 153.

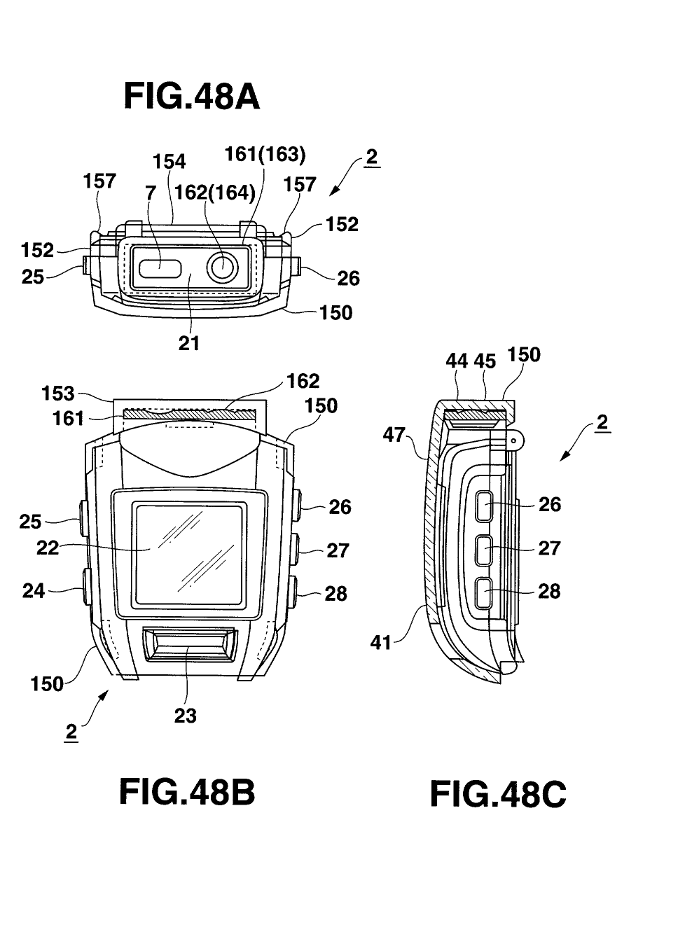

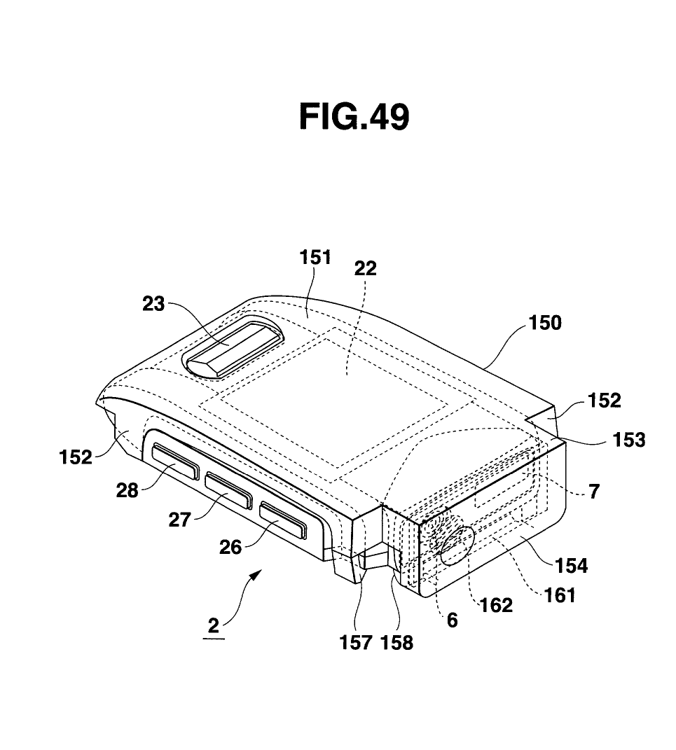

FIGS. 48A, 48B, 48C and 49 show the attachment 150 fitted over the apparatus proper 2. According to this embodiment, the attachment 150 produces advantageous effects similar to those produced by the first embodiment. In addition, the user can select one of the plates 161 and 163 having the telescopic lens 162 and filter 164, respectively, and insert it into the protrusion 153 to produce a corresponding advantageous effect.

[Fourteenth Embodiment]

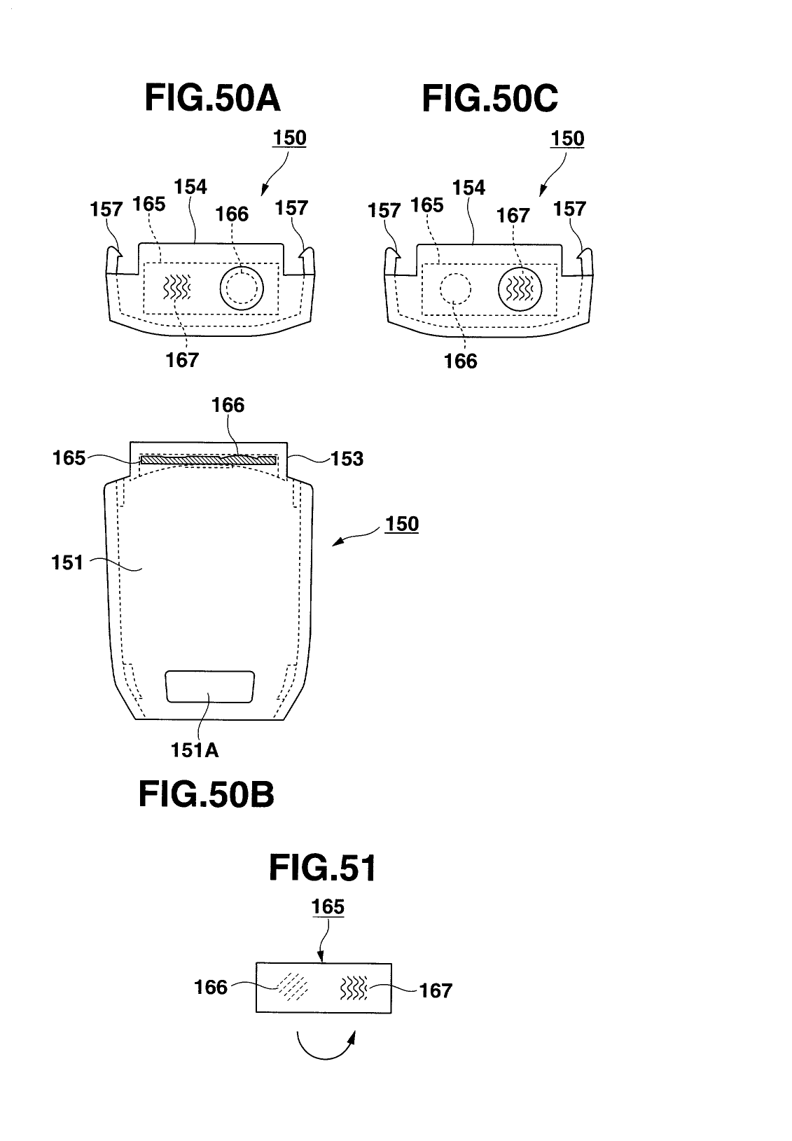

As shown in FIGS. 50A, 50B and 50C, attachment 150 has a composition similar to that of the thirteenth embodiment excluding that a transparent plastic plate 165 having a telescopic lens 166 and an optical filter 167 that fulfill corresponding functions A and B, respectively, as shown in FIG. 51, is received within the protrusion 153.

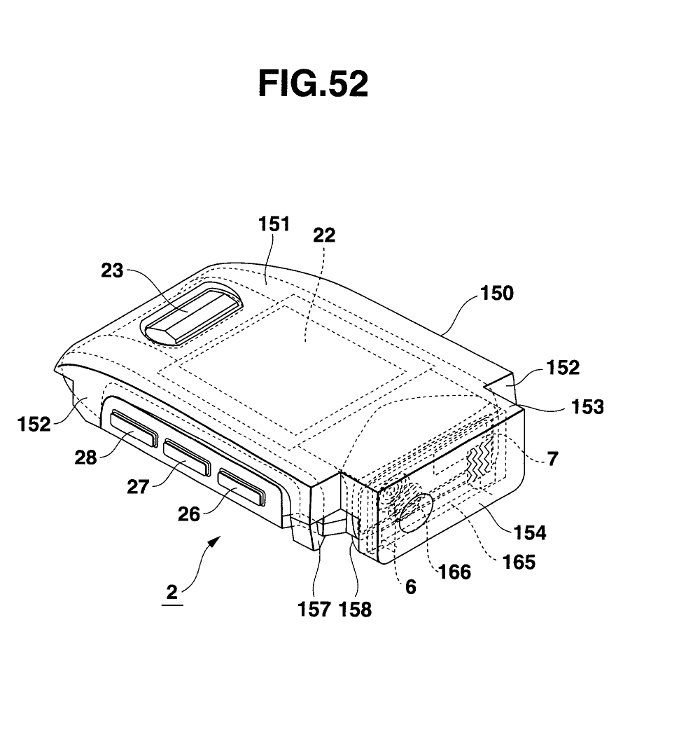

FIG. 52 shows the attachment 150 fitted over the apparatus proper 2. By reversing and inserting the plate 165 having the telescopic lens 166 and the optical filter 167 into the protrusion 153, a desired function and a corresponding advantageous effect are selected

[Fifteenth Embodiment]

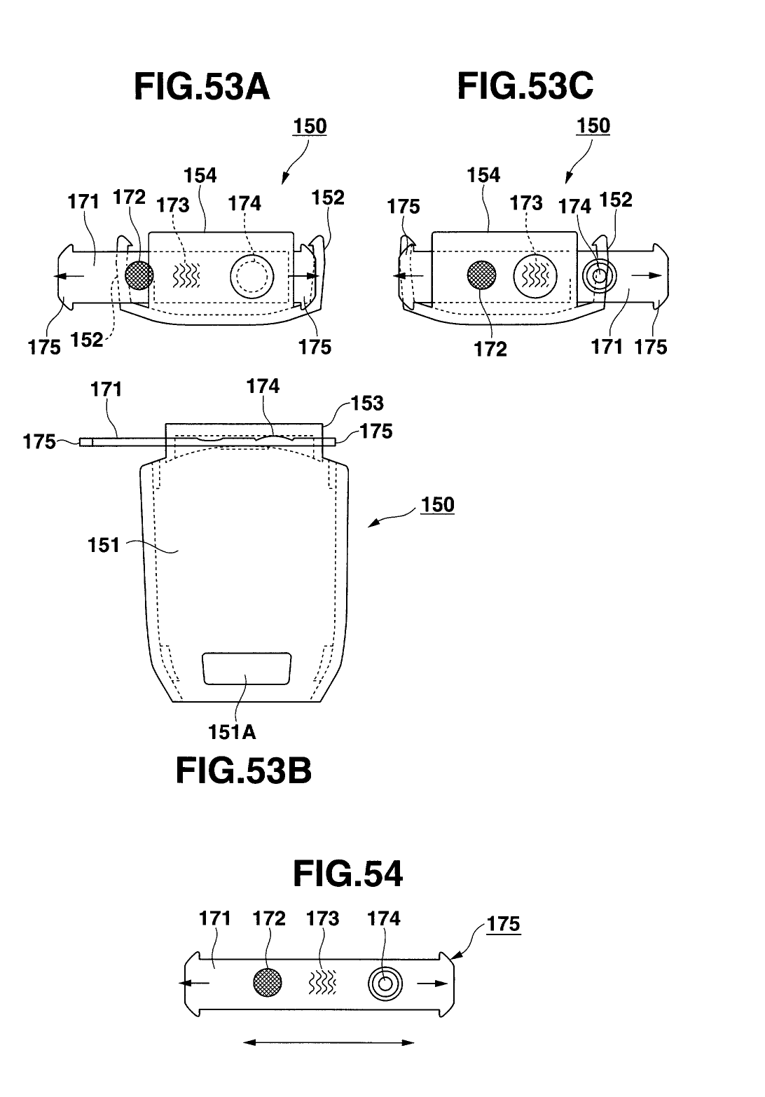

As shown in FIGS. 53A, 53B and 53C, attachment 150 has a composition similar to that of the thirteenth embodiment except that a strip-like transparent plastic plate 171 having a telescopic lens 172, an optical filter 173 and a wide angle lens 174 that have corresponding functions is disposed within the protrusion 154 so that the plate 171 is slidable lengthwise through the protrusion 153. The plate 171 has a pair of wider slip-preventing ends 175.

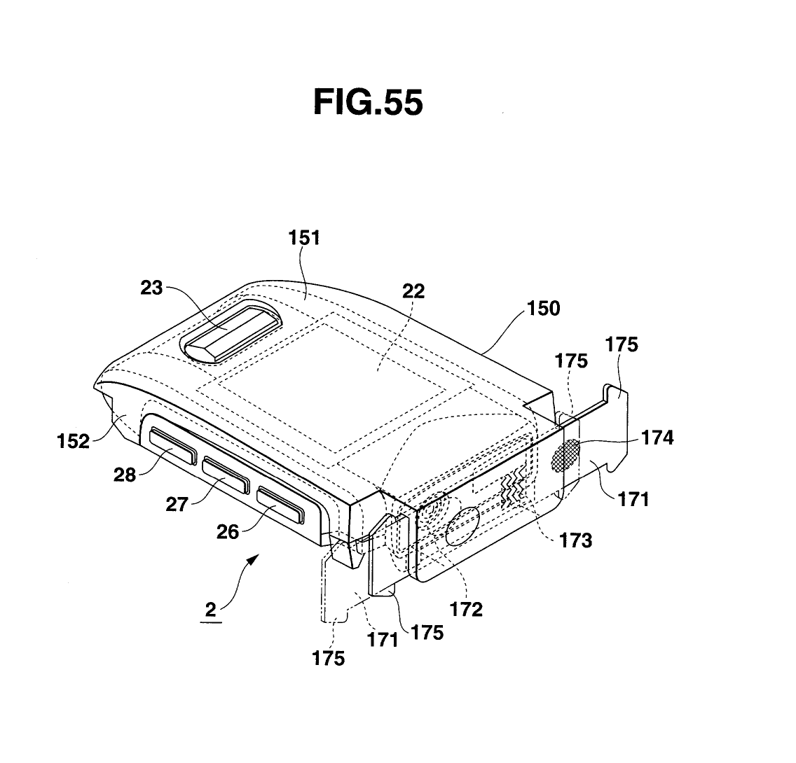

FIG. 55 shows the attachment 150 fitted over the apparatus proper 2. According to this embodiment, by sliding the plate 171 relative to the protrusion 153, the user can select any one of the three functions and corresponding advantageous effects.

[Sixteenth Embodiment]

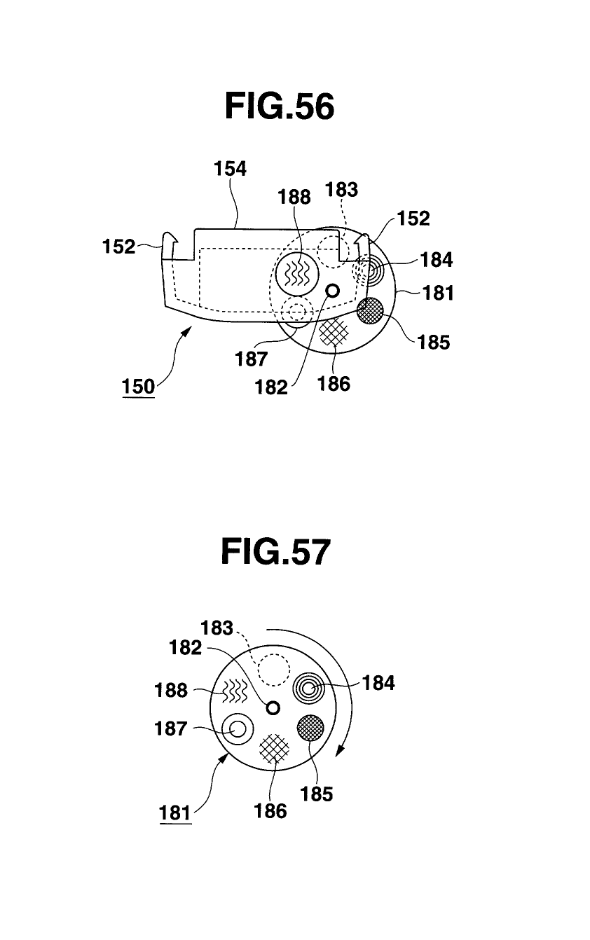

As shown in FIGS. 56-58, attachment 150 has a composition similar to that of the thirteenth embodiment except that a circular transparent plastic plate 181 is rotatably supported within the extrusion 153 around a pivotal axis 182. It has telescopic lenses 183 and 184 having magnifications of 1.45 and 2, respectively, a reflection removal filter 185, a circular polarization filter 186, a wide-angle image pickup lens 187 having a 0.65-magnification wide angle, and a sepia filter 188 providing a sepia effect, arranged along the periphery of the circular plate 181.

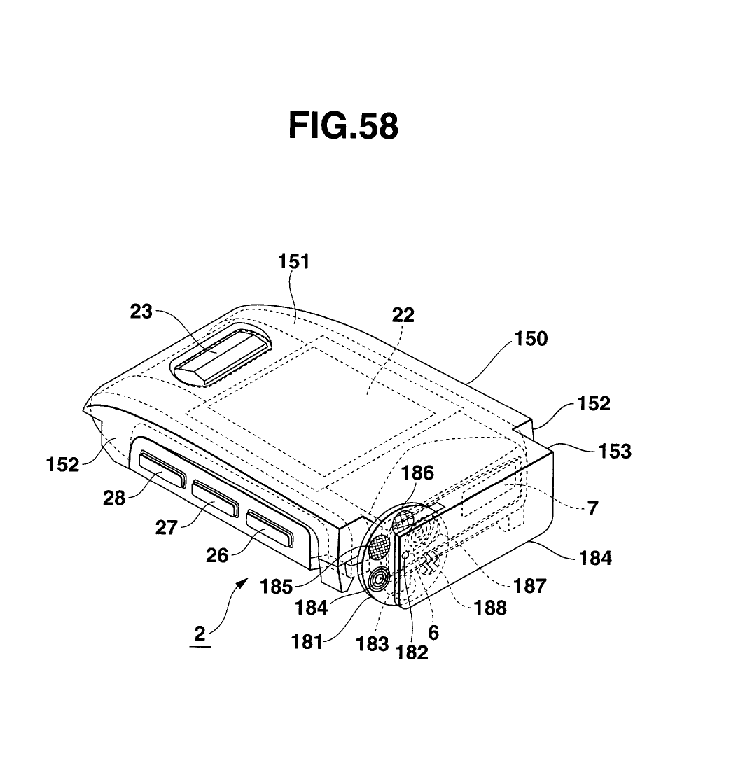

FIG. 58 shows the attachment 150 fitted over the apparatus proper 2.

According to this embodiment, by rotating the circular plate 181, the user can select one of the special optical effects.

[Seventeenth Embodiment]

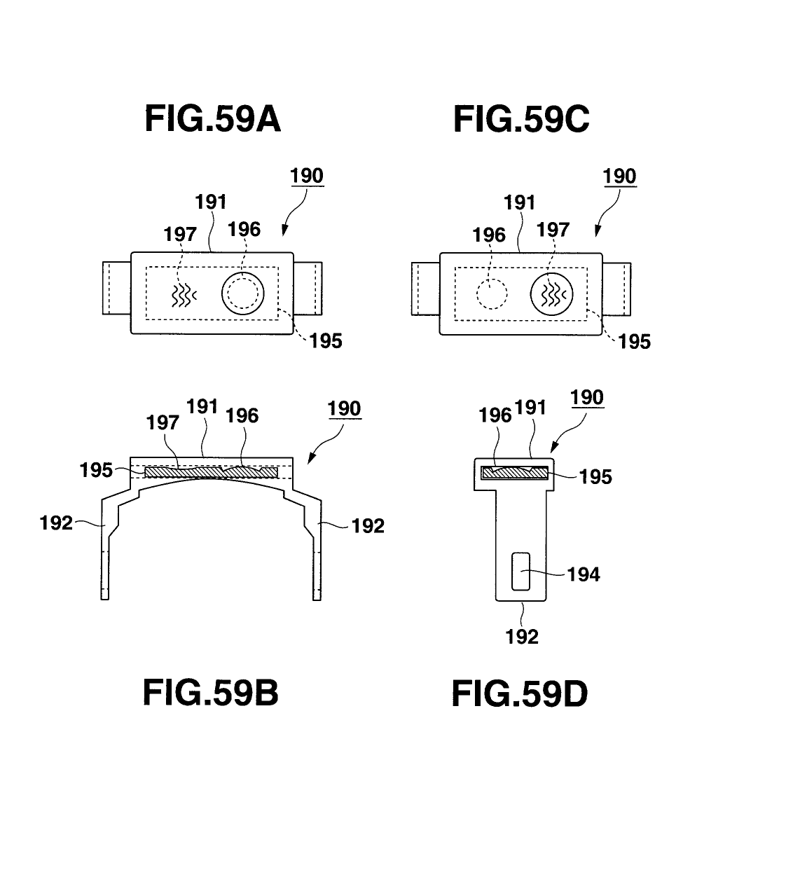

As shown in FIGS. 59A, 59B, 59C and 59D, attachment 190 comprises front 191, and right and left sides 192 each having a hole 194. The attachment 190 is made of a transparent or two-colored plastic molding.

As shown in FIGS. 59A and 59C, plate 195 having a telescopic lens 196 and an optical filter 197 is received reversibly within the front 191.

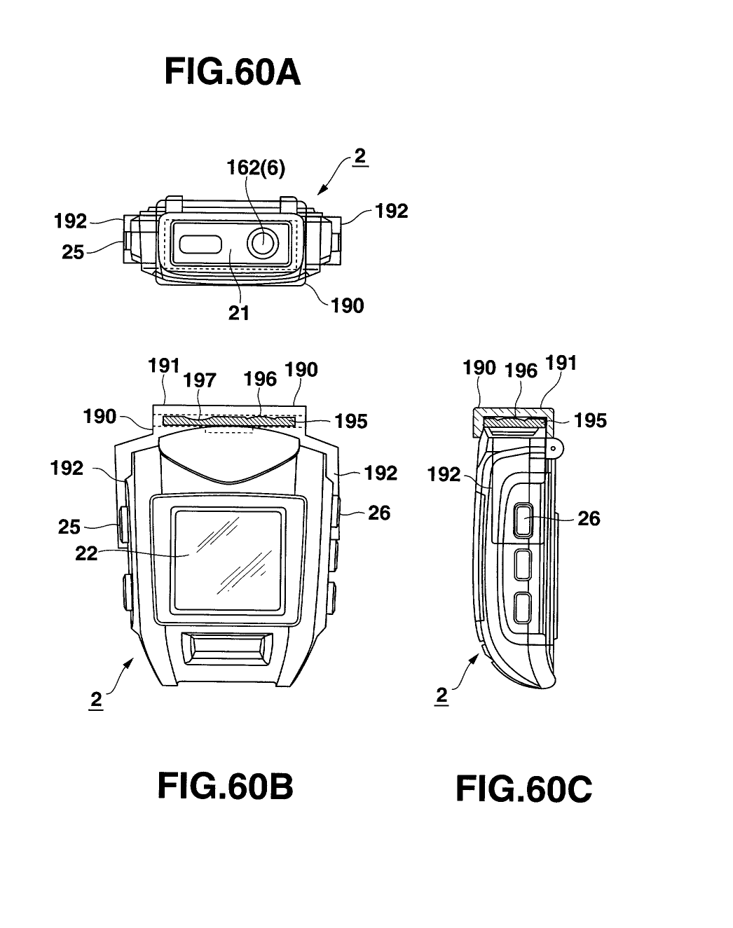

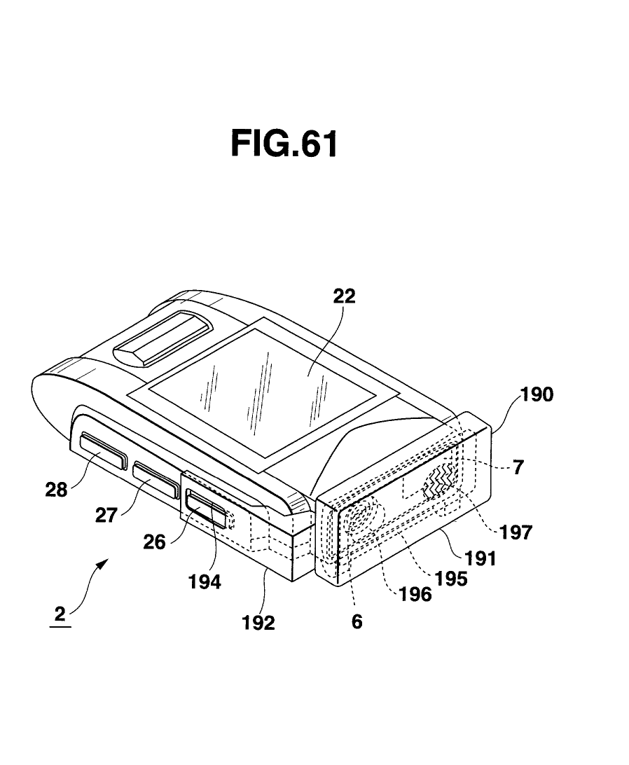

FIGS. 60A, 60B, 60C and 61 show the attachment 190 fitted over the apparatus proper 2. According to this embodiment, by reversing and inserting the plate 195 into front 191, the user can provide an image of an object having a corresponding one of the two different optical effects. Alternatively, two plates having those different image pickup functions respectively may be prepared so that one of them can be used selectively.

[Eighteenth Embodiment]

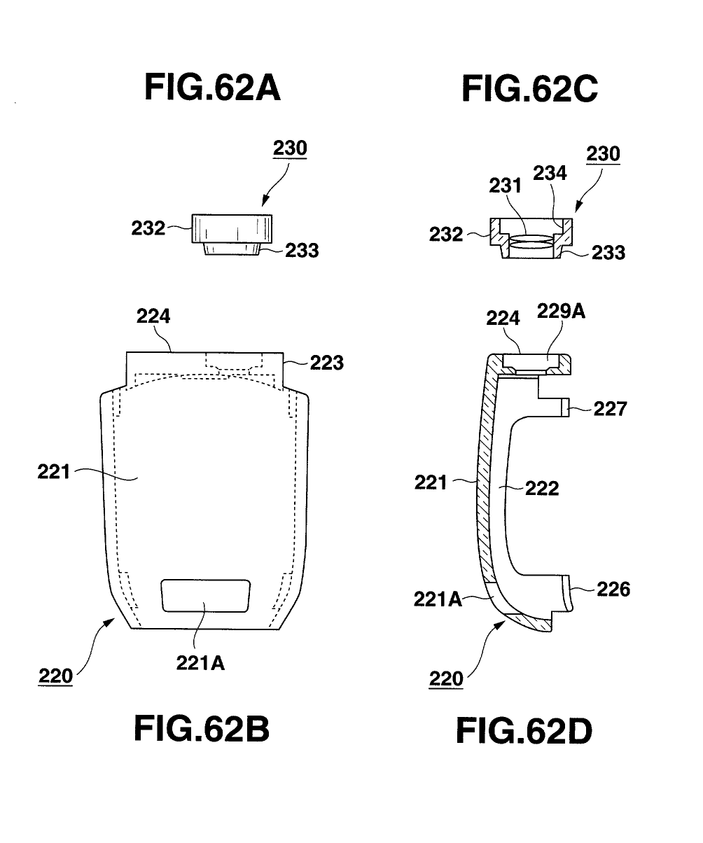

As shown in FIGS. 62B and 62D, attachment 220 comprises top 221 with a hole 221A, right and left sides 222, protrusion 223, and two pairs of hooks 226 and 227 shared by the right and left sides 222. The attachment 220 is made of a transparent or two-colored plastic molding.

As shown in FIGS. 62A and 62C, an extension unit 230 comprises a hollow cylinder 232 having a lens 231 therein, a tapering outer press-fit surface 233 and an inner tapering viewing surface 234.

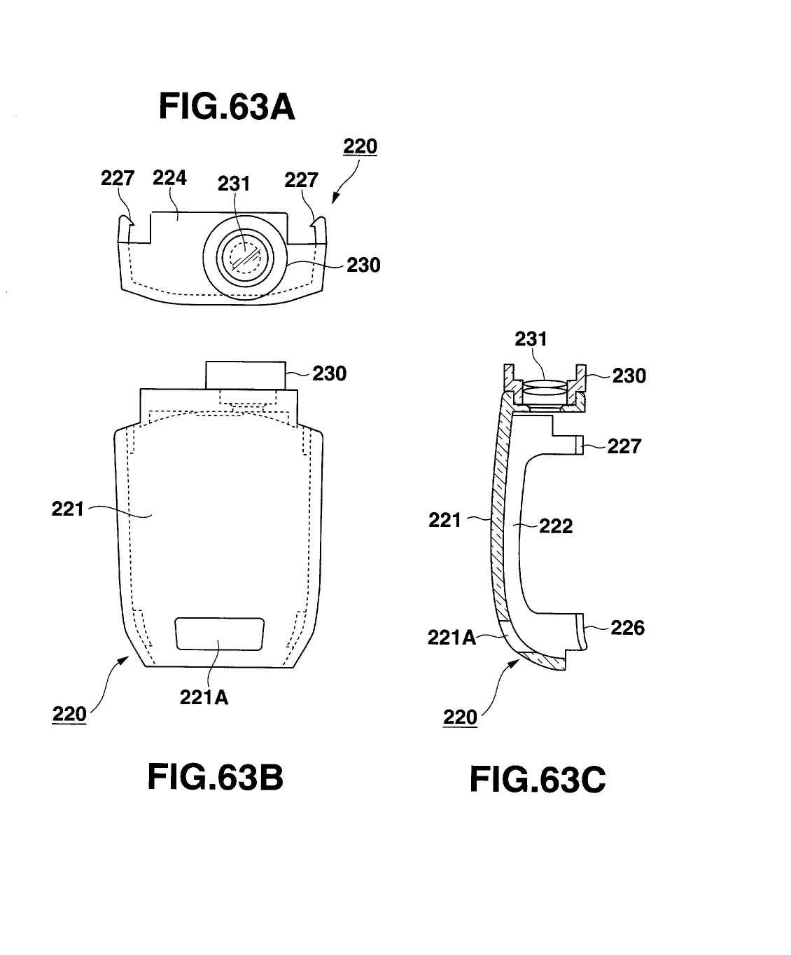

FIGS. 63A, 63B and 63C show the extension unit 230 pressed into a hole 229Ain end face 224 of the attachment 220 for fixing purposes.

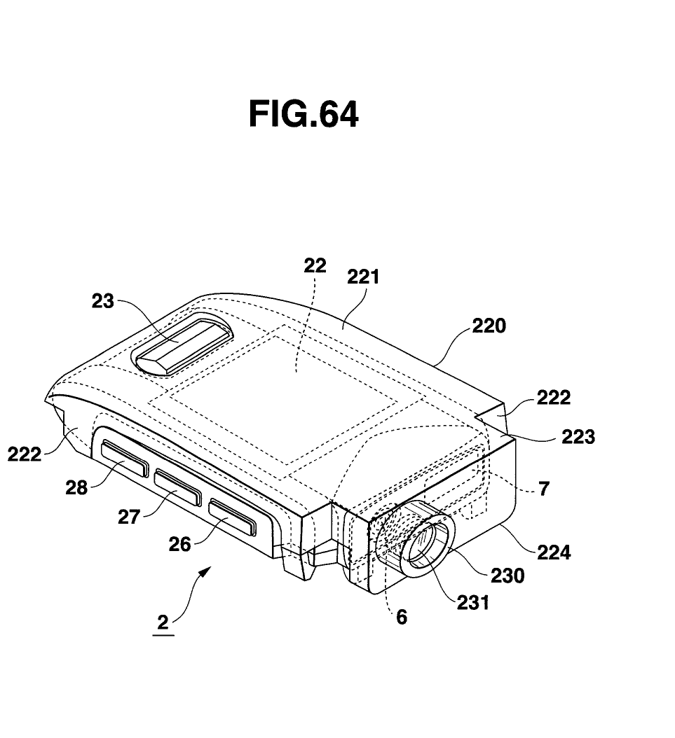

FIG. 64 shows the attachment 220 fixed over the apparatus proper 2.

As described above, according to the embodiment, advantageous effects similar to those produced by the first embodiment are obtained.

By combining the attachment 30 of the first embodiment and a different extension unit 230, the user can obtain a different image pickup function and corresponding advantageous effect.

[Nineteenth Embodiment]

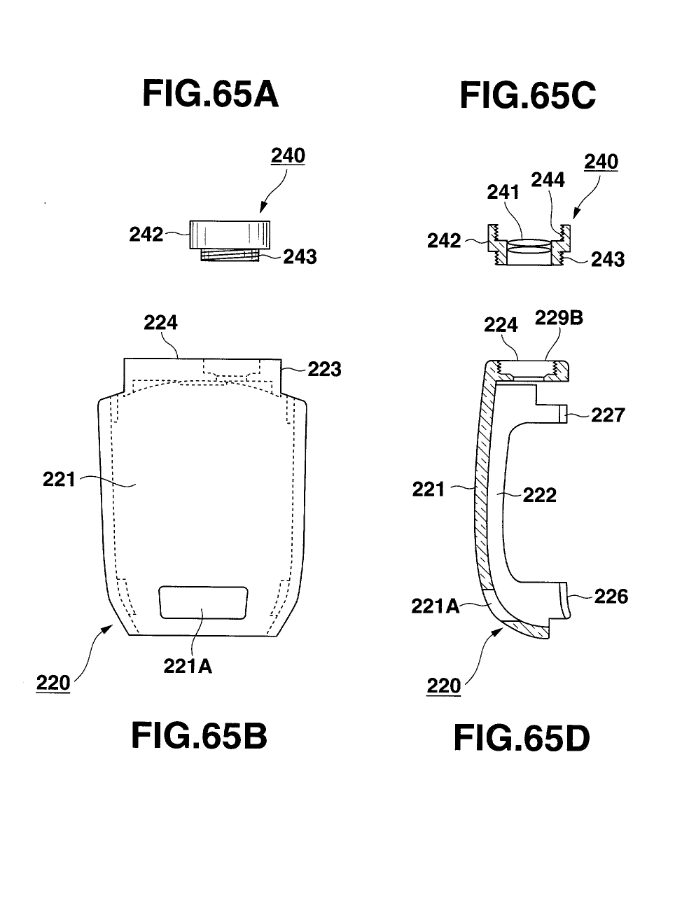

As shown in FIGS. 65B and 65D, attachment 220 has a composition similar to that of the eighteenth embodiment except that its end face 224 has a female screw hole 229B.

As shown in FIGS. 65A and 65C, extension unit 240 has a hollow cylinder 242 in which a lens 24 is provided Extension unit 240 has a male screw portion 243 screwed into female-screw hole 229B in the end face 224 of the attachment 220, and an inner female screw 244.

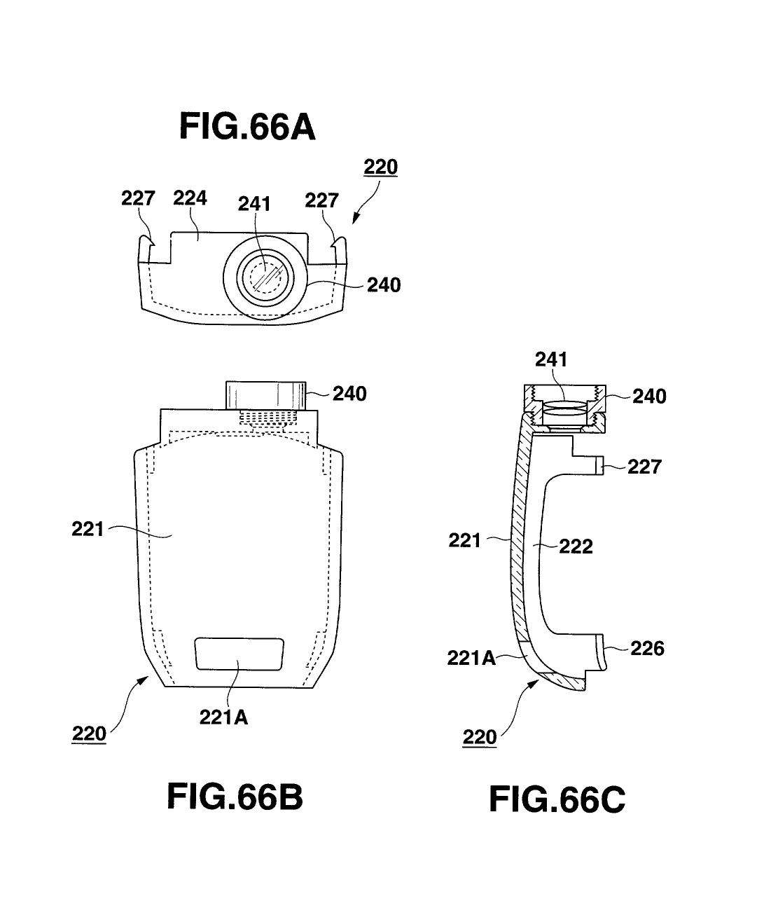

As shown in FIGS. 66A, 66B and 66C, by driving the extension unit 240 at its outer male screw portion 243 into female-screw hole 229B in the end face 224, the extension unit 240 is fixed to the attachment 220.

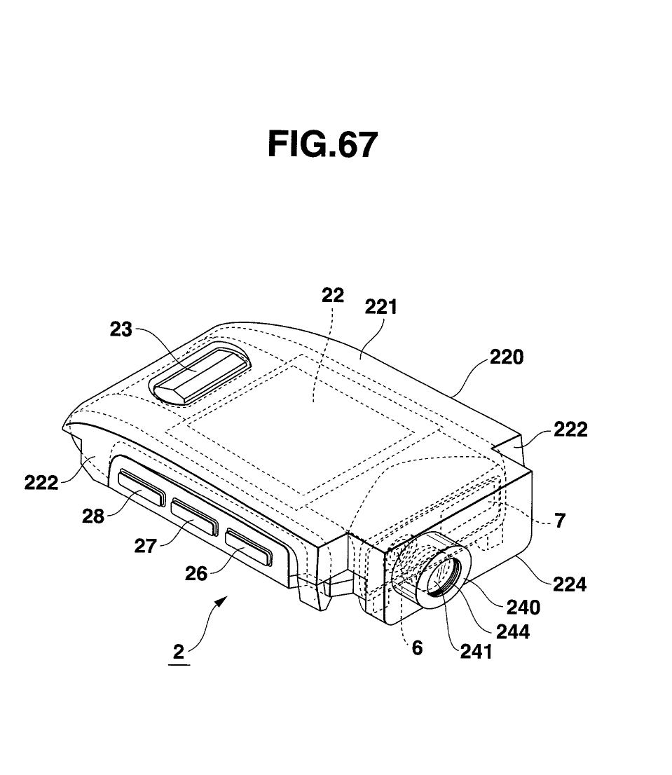

FIG. 67 shows the attachment 220 fixed to the apparatus proper 2.

This embodiment produces advantageous effects similar to those produced by the first embodiment.

By driving another extension unit into the female-screwed hole 229B in the attachment 220, a different image pickup effect is produced.

[Twentieth Embodiment]

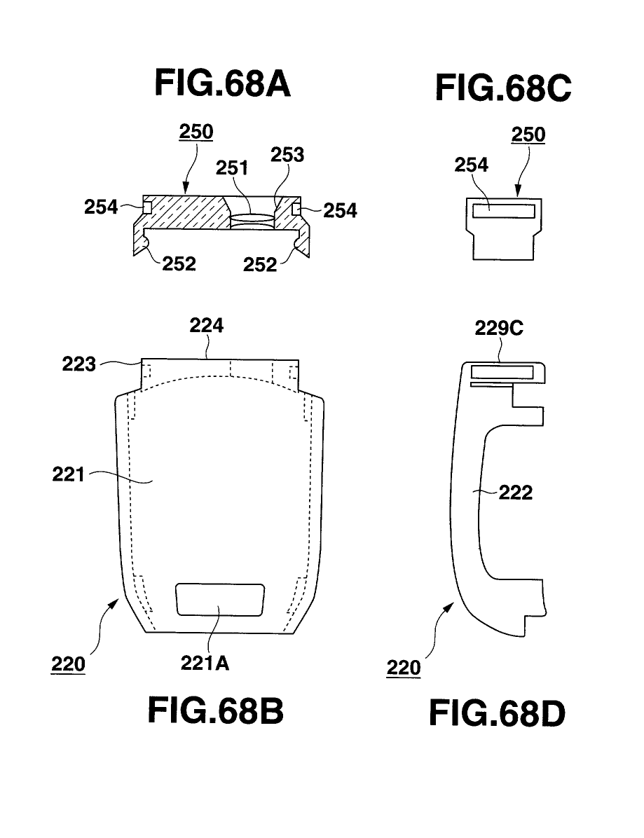

As shown in FIGS. 68B and 68D, attachment 220 has a composition similar to that of the eighteenth embodiment except that the protrusion 223 has a pair of grooves 229C each provided on a respective one of sides thereof. As shown in FIGS. 68A and 68C, the extension unit 250 has lens 251 received in a tapering hole 253, a pair of hooks 252 each provided on a respective one of ends of sides thereof and a pair of grooves 254 each provided on a respective one of the outer surfaces of sides thereof.

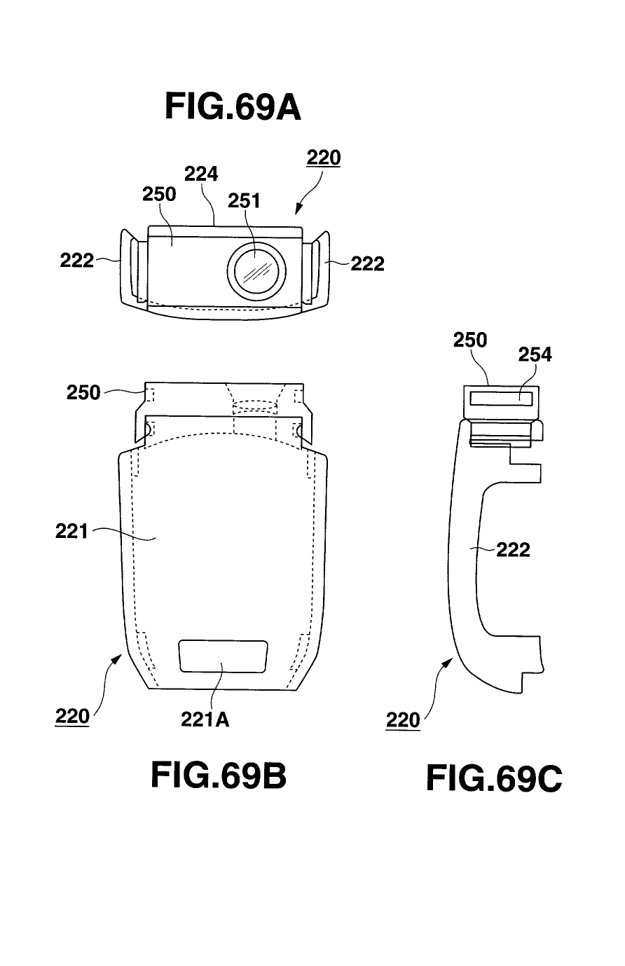

As shown in FIGS. 69A, 69B and 66C, the extension unit 250 is fixed to the attachment 220 by causing the pair of hooks 252 to be engaged in the pair of grooves 229C provided on the protrusion 223.

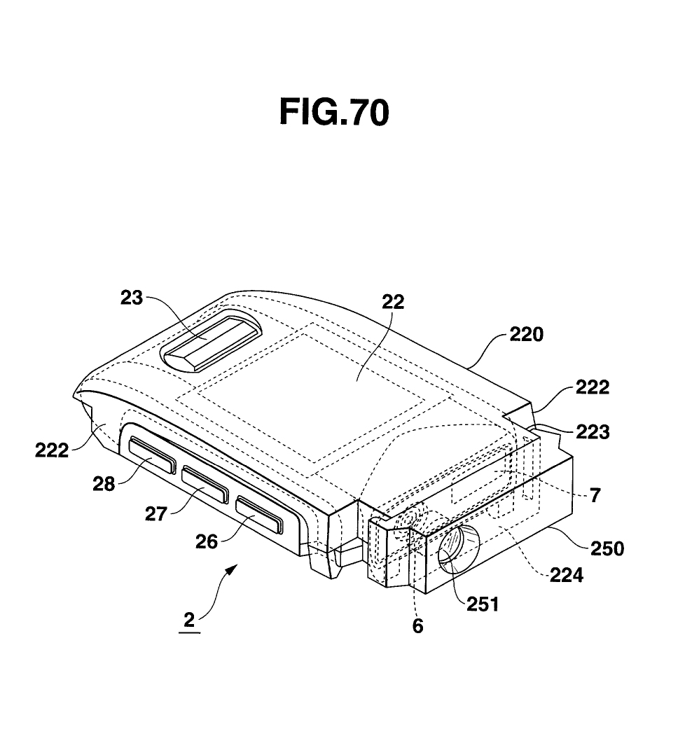

FIG. 70 shows the attachment 220 fixed to the apparatus proper 2.

This embodiment produces advantageous effects produced by the first embodiment.

By combining another extension unit (not shown) with the extension unit 250, using hook (252)-groove (254) engaging relationship, a different image pickup effect is produced.

[Twenty-first Embodiment]

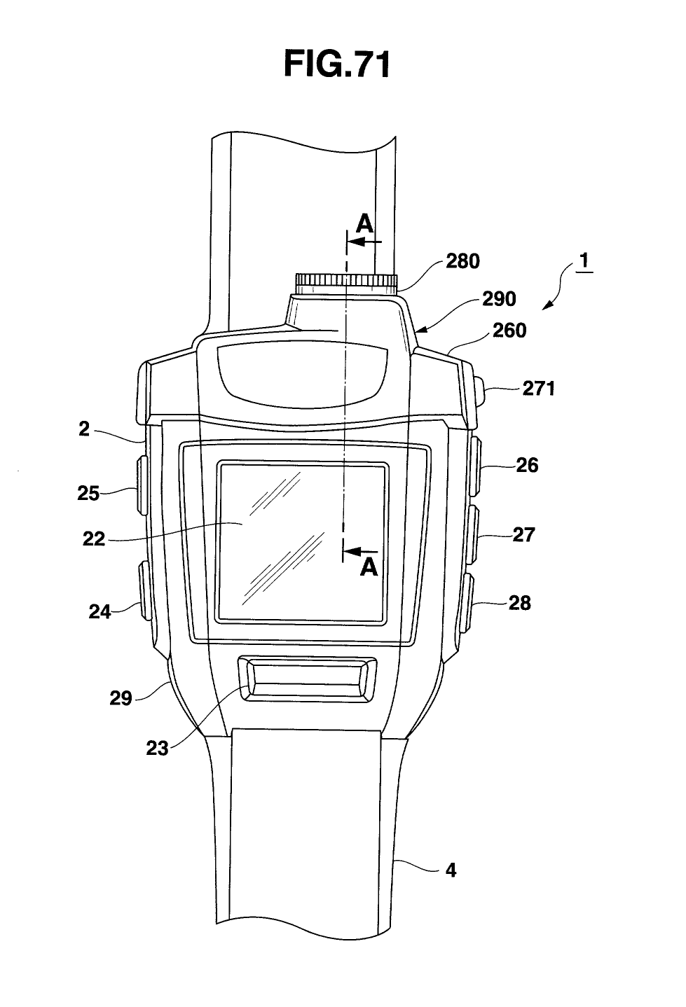

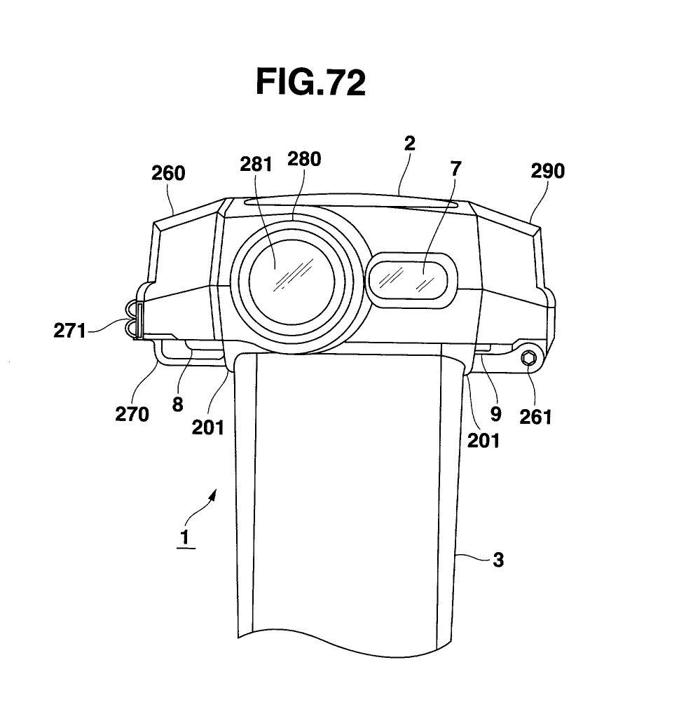

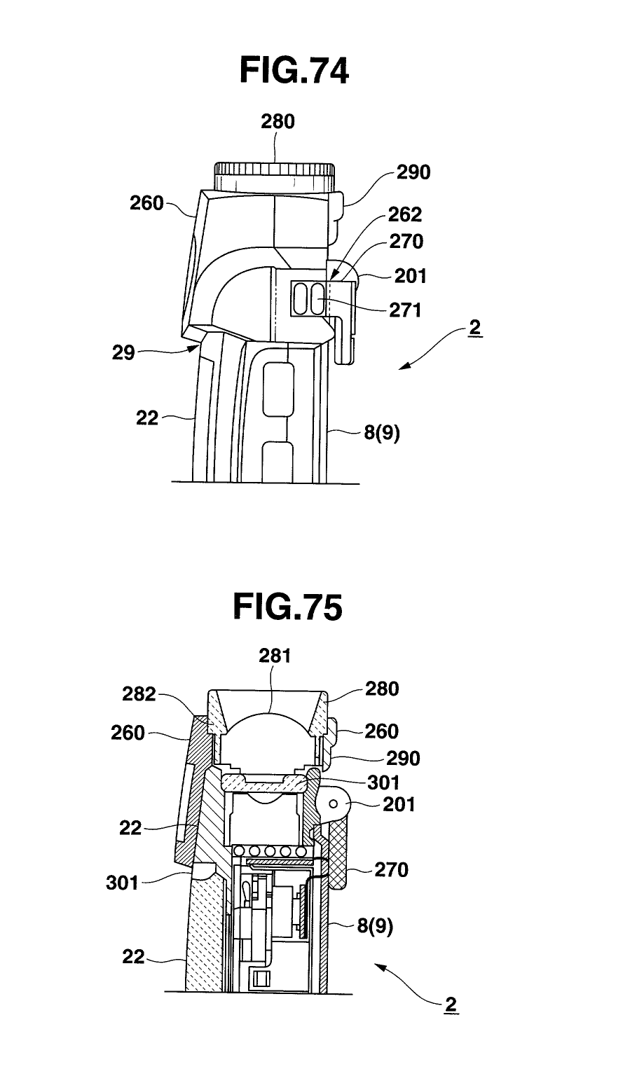

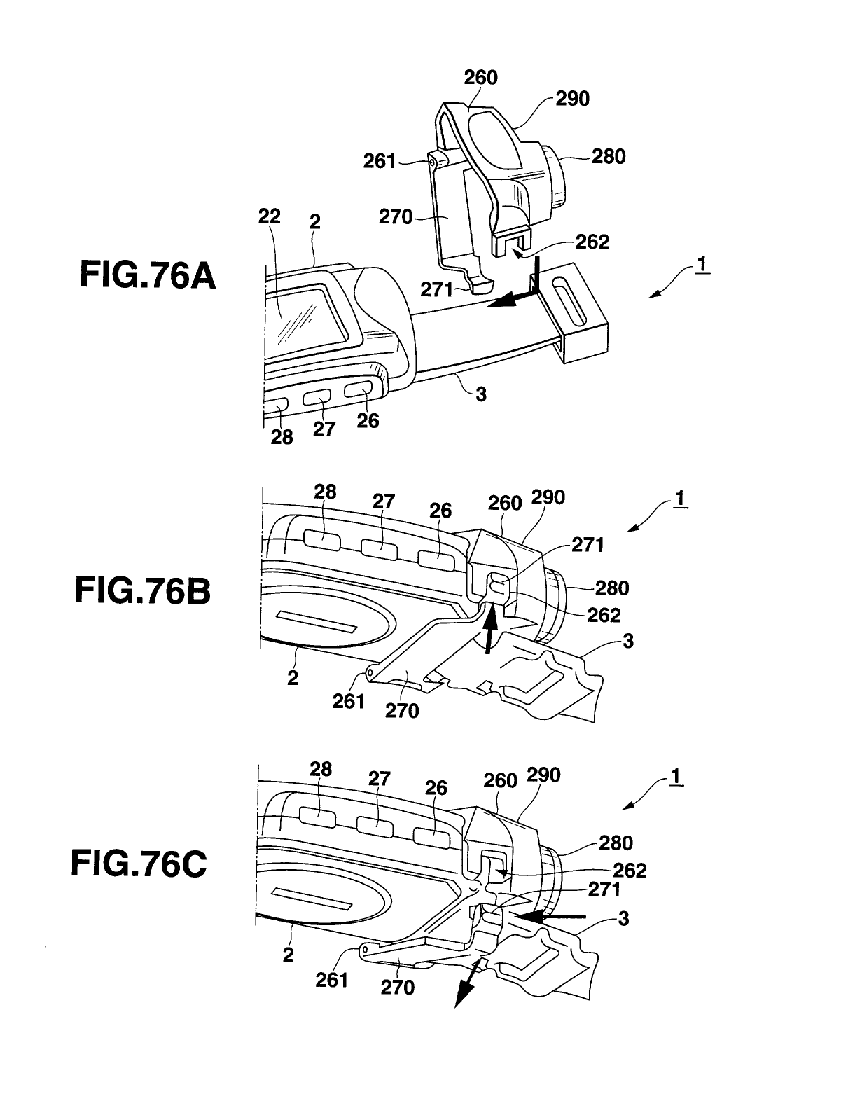

As shown in FIGS. 71-75, 76A, 76B and 76C, attachment 290 comprises cover 260, and a fastening belt 270 turnable around a pin 261 provided in the cover 260.

The cover 260 has an inner surface designed so as to fit over the outer shape of the apparatus proper 2 to thereby prevent the attachment 290 from being unsteady.

An extension unit 280 having telescopic lens 281 is screwed onto an end face of cover 260. Reference numerals 282 and 301 denote a waterproof packing 282 and a transparent cover, respectively.

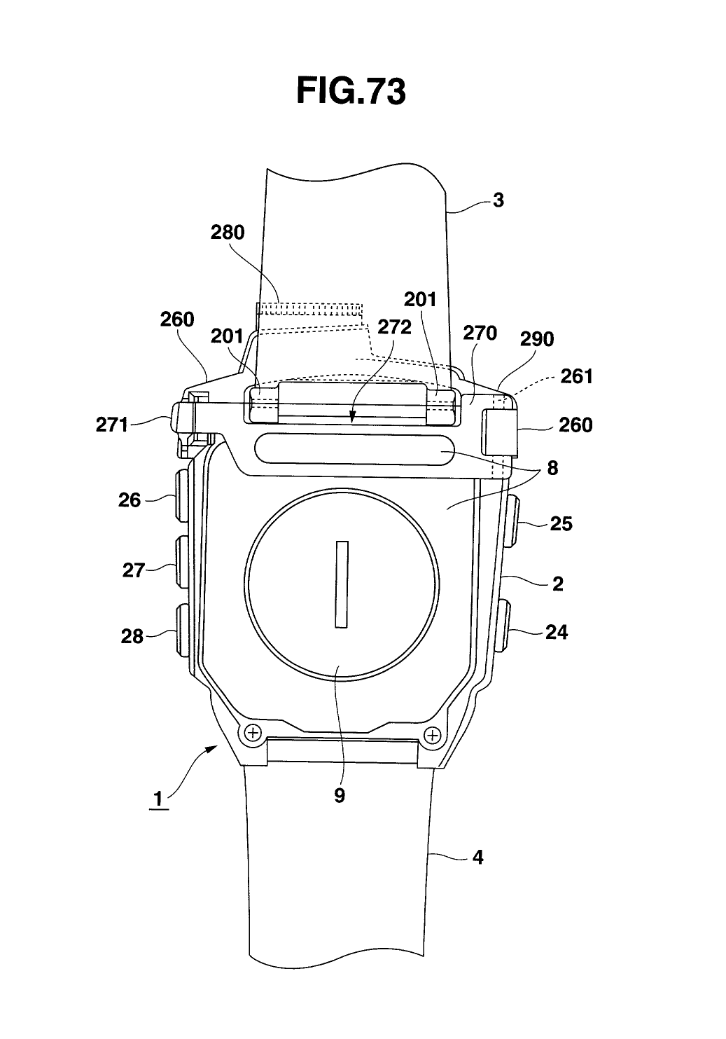

As shown in FIG. 73, the belt 270 has a recess 272 in the end face thereof. When the attachment 290 is attached to the apparatus proper 2, the attachment 290 is brought into contact with the back plate 8 so as to avoid in the recess 272 the band attaching units 201 of the wristband 1 protruding from the rear of the apparatus proper 2 to thereby fix the belt 270 to the back plate 8 securely.

As shown in FIGS. 76A and 76B, when the attachment 290 is fixed to the apparatus proper 2, cover 260 on which the extension unit 280 having the telescopic lens 281 is screwed is fitted over the apparatus proper 2 from above (FIG. 76A).

The belt 270 is then turned around pin 261 so as to cover the back of the apparatus proper 2 and a push 271 provided at a free end of the belt 270 is fitted into an opening 262 in the cover 260 (FIG. 76B). The push 271 has a pawl or a leaf spring (not shown) that is engaged in the opening 262 in the cover 260.

That is, the attachment 290 is easily fixed to the apparatus proper 2 in a manner in which the cover 260 and the fastening belt 270 hold the apparatus proper 2 from above and below without being unsteady or slipping away from the apparatus proper 2.

When the attachment 290 is to be removed from the apparatus proper 2, the pawl of push 271 is disengaged from the opening 262 in the attachment 290 by slightly pulling the push 271 away from the attachment 290.

According to this embodiment, formation of exposed male screw threads on the outer surface of the apparatus proper 2 on which the extension unit 290 is to be screwed is not required. Thus, even when no attachment 290 is attached to the apparatus proper 2, the appearance of the apparatus proper 2 gives no bad impression.

By selecting a different extension unit 280 to be set before image pickup lens 6, attaching the selected extension unit to the attachment 290, and then attaching the thus combined extension unit and attachment 290 to the apparatus proper 2, the special image pickup effect is given to the picked-up image.

While in the present embodiment the extension unit 280 is illustrated as being attached to the attachment 290, it may be arranged that the bezel 29 of the apparatus proper 2 is disposed exchangeably and the extension unit 280 is attached to the bezel 29.

The apparatus 1 may has an accessory (not shown) to which extension unit 280 is attached.

While in the above embodiments the image pickup apparatus is illustrated, the present invention is not limited to them. The apparatus may be replace with another electronic wrist device or a portable telephone or communication terminal comprising a camera unit. The camera unit may have any composition. The details of the composition of the apparatus are changeable as requested, of course.

What is claimed is:

1. A portable image pickup apparatus comprising:
an apparatus proper that comprises a camera unit, a lens for said camera unit, and a band attached to a band attaching unit of said apparatus proper for wearing the apparatus proper on a user's body; and
an attachment attachable to said apparatus proper so as to avoid said band-attaching unit, said attachment having a light transmission part that covers at least said lens.

2. The portable image pickup apparatus according to claim 1, wherein said attachment comprises a hook being engaged with an outer periphery of said apparatus proper for fixing purposes.

3. The portable image pickup apparatus according to claim 2, wherein said hook is integral with said attachment.

4. The portable image pickup apparatus according to claim 2, wherein said hook is separated from said attachment; and comprising:
a spring for urging said hook towards said apparatus proper for fixing purposes.

5. The portable image pickup apparatus according to claim 1, wherein said attachment comprises a belt for fastening said attachment to said apparatus proper.

6. The portable image pickup apparatus according to claim 1, wherein said attachment has a hole in which said apparatus proper is engaged at an outer periphery thereof.

7. The portable image pickup apparatus according to claim 1, wherein said apparatus proper comprises a spring rod for attaching said band to said apparatus proper, and said attachment comprises a portion for fastening said attachment to said spring rod.

8. The portable image pickup apparatus according to claim 1, wherein said light transmission part of said attachment has a special image pickup function unit for producing a special image pickup effect in image pickup.

9. The portable image pickup apparatus according to claim 1, wherein said special image pickup function unit is provided removably to said attachment.

10. The portable image pickup apparatus according to claim 1, wherein said apparatus proper further comprises a display unit for displaying an picked-up image; and
said attachment being made of a material having light transmission parts that aligns with said lens and said display unit.

11. The portable image pickup apparatus according to claim 1, wherein said apparatus proper comprises a pair of band attaching units each provided at a respective one of ends thereof for attaching a wristband thereto.

12. An attachment for a portable image pickup apparatus comprising an apparatus proper that comprises a camera unit, a lens for the camera unit, and a band attached to a band attaching unit of the apparatus proper for wearing the apparatus proper on a user's body, said attachment being attachable to the apparatus proper so as to avoid the band-attaching unit, said attachment providing a light transmission part that covers at least the lens.

13. The attachment according to claim 12, wherein said attachment comprises a hook being engaged with an outer periphery of the apparatus proper for fixing purposes.

14. The attachment according to claim 13, wherein said hook is integral with said attachment.

15. The attachment according to claim 13, wherein said hook is separated from said attachment; and comprising:
a spring for urging said hook towards the apparatus proper for fixing purposes.

16. The attachment according to claim 12, wherein said attachment comprises a belt for fastening said attachment to the apparatus proper.

17. The attachment according to claim 12, wherein said attachment has a hole in which the apparatus proper is engaged at an outer periphery thereof.

18. The attachment according to claim 12, wherein said light transmission part of said attachment has a special image pickup function unit for producing a special image pickup effect in image pickup.

19. The attachment according to claim 18, wherein said special image pickup function unit is provided removably to said attachment.

20. The attachment according to claim 12, wherein the apparatus proper further comprises a display unit for displaying an picked-up image; and
said attachment being made of a material having light transmission parts that aligns with the lens and the display unit.
